(19) United States
(12) Patent Application Publication
(10) Pub. No.: US 2026/0164381 A1
(43) Pub. Date: Jun. 11, 2026

(54) TIME SYNCHRONIZATION IN WIRELESS BATTERY MANAGEMENT SYSTEMS

(71) Applicant: Texas Instruments Incorporated, Dallas, TX (US)

(72) Inventors: Kwang Seop Eom, Frisco, TX (US); Minghua Fu, Plano, TX (US); Jyothsna Kunduru, Plano, TX (US); Ariton E. Xhafa, Plano, TX (US); Seohong Jung, Carrollton, TX (US); Dag Grini, Skedsmokorset (NO)

(21) Appl. No.: 19/213,653

(22) Filed: May 20, 2025

Related U.S. Application Data
(60) Provisional application No. 63/730,233, filed on Dec. 10, 2024.
(60) Provisional application No. 63/734,939, filed on Dec. 17, 2024.
(60) Provisional application No. 63/763,006, filed on Feb. 25, 2025.

(51) Int. Cl. H04W 56/00; B60L 58/10; B60R 16/023; H04W 4/48

(52) U.S. Cl. CPC H04W 56/0015; B60R 16/0232; H04W 4/48; B60L 58/10

(57) ABSTRACT

An example apparatus includes: a transceiver; and programmable circuitry coupled to the transceiver and configurable to cause the transceiver to: wirelessly transmit a first message to a first monitor circuit, the first message to prompt the first monitor circuit to perform a first battery measurement upon receipt; and transmit a second message to a second monitor circuit over a wired medium after transmitting the first message so that the first and second monitor circuits synchronously perform battery measurements.

### CROSS REFERENCE TO RELATED APPLICATION

This patent application claims the benefit of and priority to U.S. Provisional Patent Application No. 63/730,233 filed Dec. 10, 2024, U.S. Provisional Patent Application No. 63/734,939 filed Dec. 17, 2024, and U.S. Provisional Patent Application No. 63/763,006 filed Feb. 25, 2025. U.S. Provisional Patent Application Nos. 63/730,233, 63/734,939, and 63/763,006 are hereby incorporated herein by reference in their entirety.

### TECHNICAL FIELD

This description relates generally to batteries and, more particularly, to time synchronization in Wireless Battery Management Systems (WBMS).

### BACKGROUND

Hybrid electric vehicles (HEVs) and electric vehicles (EVs) are powered by battery systems that include batteries such as lithium-ion batteries. Battery systems may also include a battery management system to monitor the health of the batteries and report the health to a main electronic control unit (ECU) of the HEVs or EVs. The health of the batteries may be impacted by a wide range of conditions.

### SUMMARY

For time synchronization in wireless battery management systems, an example apparatus includes: a transceiver, and programmable circuitry coupled to the transceiver and configurable to cause the transceiver to: wirelessly transmit a first message to a first monitor circuit, the first message to prompt the first monitor circuit to perform a first battery measurement upon receipt, and transmit a second message to a second monitor circuit over a wired medium after transmitting the first message so that the first and second monitor circuits synchronously perform battery measurements.

An example method includes wirelessly transmitting a first message to a first monitor circuit the first message to prompt the first monitor circuit to perform a first battery measurement upon receipt, and transmitting a second message to a second monitor circuit over a wired medium after transmitting the first message so that the first and second monitor circuits synchronously perform battery measurements.

An example system includes a primary device, a first monitor circuit coupled to a first battery cell, and a second monitor circuit coupled to the primary device over a wired medium and coupled to a second battery cell, wherein the primary device is configurable to: wirelessly transmit a first message that prompts the first monitor circuit to perform a first battery measurement upon receipt, and transmit a second message to a second monitor circuit over the wired medium after transmitting the first message so that the first and second monitor circuits synchronously perform battery measurements.

### BRIEF DESCRIPTION OF THE DRAWINGS

FIG. 1 is an illustrative example of a wireless battery management system (WBMS).

FIG. 2 is a block diagram of a first example implementation of the WBMS of FIG. 1.

FIG. 3 is a block diagram of a second example implementation of the WBMS of FIG. 1.

FIG. 4 is a block diagram of a third example implementation of the WBMS of FIG. 1.

FIG. 5 is a block diagram of a fourth example implementation of the WBMS of FIG. 1.

FIG. 6 is a block diagram of a fifth example implementation of the WBMS of FIG. 1.

FIGS. 7A and 7B are illustrative example of super frame intervals usable by the example implementation of the WBMS of FIG. 6.

FIG. 8 is an illustrative example of timing synchronization between a primary device and secondary device in the example implementation of the WBMS of FIG. 6.

FIGS. 9A and 9B are illustrative examples of timing synchronization between the battery controller and a primary device in the example implementation of the WBMS of FIG. 6.

FIG. 10A is an illustrative example of a schedule protocol that may be implemented within the WBMS of FIG. 6.

FIG. 10B is an illustrative example of a sequence definition that may instruct devices within the WBMS 100 of FIG. 6 to perform measurements periodically.

FIG. 10C is an example implementation of the sequence definition of FIG. 10B.

FIG. 11 is an illustrative example of a just-in-time protocol that may be implemented within the WBMS of FIG. 6.

FIG. 12 is an illustrative example of Bluetooth Low Energy (BLE) Frequency channels utilized by the primary devices within the WMBS of FIG. 6.

FIG. 13 is an illustrative example of primary devices within the WMBS of FIG. 6 changing BLE frequency channels over time.

FIG. 14 is a flowchart representative of example machine-readable instructions or example operations that may be at least one of executed, instantiated, or performed using an example programmable circuitry implementation of a controller device of FIG. 6 to implement the just-in-time protocol shown in at least FIG. 11.

FIG. 15 is a flowchart representative of example machine-readable instructions or example operations that may be at least one of executed, instantiated, or performed using an example programmable circuitry implementation of a controller device of FIG. 6 to implement the schedule protocol shown in at least FIG. 10A.

FIG. 16 is a flowchart representative of example machine-readable instructions or example operations that may be at least one of executed, instantiated, or performed using an example programmable circuitry implementation of the battery controller device of FIG. 6 to utilize measurement data and optionally implement one or more packet loss response techniques.

FIG. 17 is a flowchart representative of example machine-readable instructions or example operations that may be at least one of executed, instantiated, or performed using an example programmable circuitry implementation of the first and second primary devices in the WBMS of FIG. 6.

FIG. 18 is a flowchart representative of example machine-readable instructions or example operations that may be at least one of executed, instantiated, or performed using an example programmable circuitry implementation of the second primary device in the WBMS of FIG. 6.

FIG. 19 is a flowchart representative of example machine-readable instructions or example operations that may be at least one of executed, instantiated, or performed using an example programmable circuitry implementation of a battery quality (BQ) circuit in the WBMS of FIG. 6.

FIG. 20 is a flowchart representative of example machine-readable instructions or example operations that may be at least one of executed, instantiated, or performed using an example programmable circuitry implementation of the BQ pack-level device of FIG. 6.

FIG. 21 is a block diagram of an example processing platform including programmable circuitry structured to execute, instantiate, or perform the example machine-readable instructions or perform the example operations of FIGS. 14-20 to implement the WBMS 100 of FIG. 6.

The drawings are not necessarily to scale. Generally, the same reference numbers in the drawing(s) and this description refer to the same or similar (functionally or structurally) features or parts. Although the drawings show regions with clean lines and boundaries, some or all of these lines and boundaries may be idealized. In reality, the boundaries or lines may be unobservable, blended or irregular.

### DETAILED DESCRIPTION

Many HEVs and EVs include a system of batteries. Using multiple distributed batteries enables an increased amp-hour capacity than would otherwise be attainable with a single battery. The increased amp-hour capacity improves the functionality of the system (e.g., increased range, torque, or speed of the vehicle, etc.) compared to single battery alternatives. In some implementations of multiple distributed batteries, one or more individual batteries connect to a controller that coordinates operations at a system-level. In some examples, the individual battery cells or the circuits coupled to the battery cells may be called battery modules, secondary batteries, secondary nodes, secondary network nodes, secondary circuits, monitor circuits, etc. Similarly, the controller may be called a battery controller, a primary node, a primary network node, a primary controller, etc.

Some HVs and EVs enable communication between the battery modules and controller through a series of wired connections. HVs and EVs may also or alternatively use wireless connections to enable communication between the battery modules and the controller. In some examples, implementations utilizing wireless communication may be referred to as wireless battery management systems (WBMSs). In some examples, WBMSs are used instead of wired alternatives because WBMSs reduce weight, complexity, and cost as compared to utilizing wired connections through a vehicle. For example, wired battery systems generally include more components (including but not limited to choke capacitors for isolation/protection between high and low voltage) and require more complexity to repair than WBMSs.

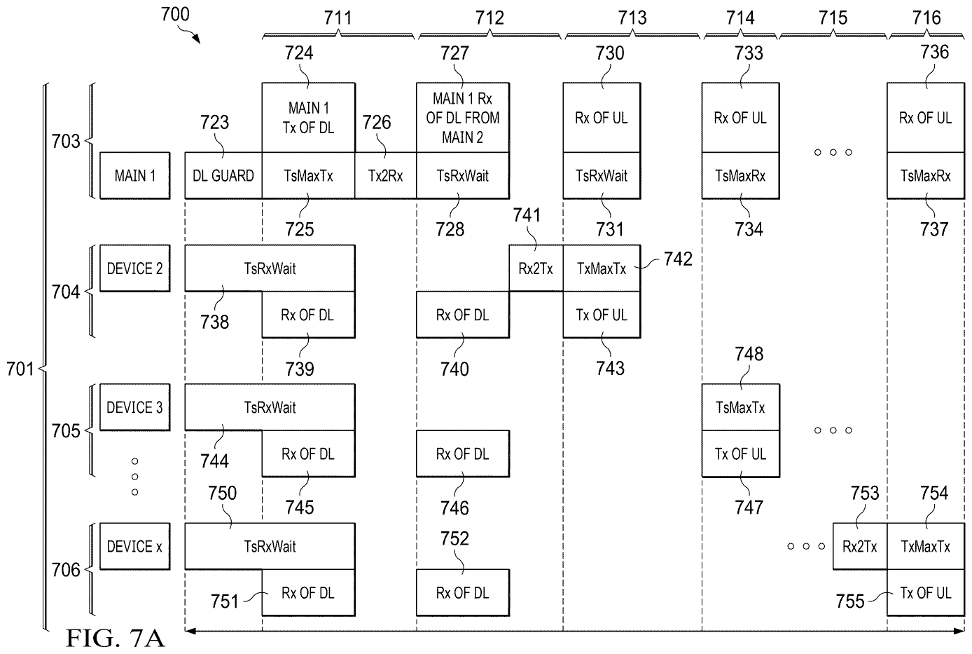

WBMSs may communicate over different protocols based on the use case. For example, in some automotive applications, industry members may use a WBMS superframe to establish communication between multiple battery modules and a controller. As used herein, the term “superframe” refers to a scheduled data exchange window that aggregate several bi-directional transmission slots. As used herein, a superframe may refer to a Transmission System 1 (T1) framing standard or any other bi-directional scheduled transmission protocol. Superframes are described further in connection with at least FIGS. 7A and 7B.

As the design of HEVs and EVs has evolved and complexity has increased, industry members have increased the number of battery cells within a given vehicle to support electric or hybrid Sports Utility Vehicles (SUVs), electric or hybrid busses, etc. However, increasing the number of battery cells within a given superframe interval decreases the amount of time within the superframe interval that is assigned to any one battery cell. These shorter communication windows provide fewer opportunities for retransmissions, which in turn decreases the robustness of the WBMS. The shorter communication windows also introduce longer delays between consecutive transmissions from the same battery cell, which in turn reduces the throughput of the communication system.

Devices within battery systems communicate with one another to support any number of applications and use cases. For example, in some wired battery systems, a controller device communicates with Battery Quality (BQ) circuits to synchronously perform battery health measurements on individual battery cells and groups of battery cells. However, as the design of HEVs and EVs has evolved and complexity has increased, industry members have developed WBMSs in which some BQ circuits communicate wirelessly to a controller device while other BQ circuits communicate over a wired connection. Such WBMSs may be referred to herein as hybrid battery systems due to their mix of wireless and wired connections. Hybrid battery systems cannot support the techniques used to synchronously perform battery health measurements in wired battery systems because transmission latencies over a wired medium are inherently different, and generally faster, than transmission latencies over a wireless medium. Timing synchronization in hybrid battery systems is also challenging because wireless transmissions are generally less robust and suffer higher probabilities of packet loss than wired transmissions. Moreover, wired mediums generally have deterministic latencies while the latency of wireless mediums can vary based on network conditions. This decreased robustness results in different amounts of transmission latency variance for different BQ circuits and greater unpredictability for hybrid battery systems than wired battery systems. Examples of synchronous communications include communications that are concurrent, communications that are at the same time, communications that substantially overlap in time, etc.

Example methods, apparatus, and systems described herein enable next generation WBMSs to continue supporting the functionality and performance of prior WBMSs, regardless of whether the next generation WBMSs have more battery cells than the prior WBMSs or form a hybrid battery system with wired connections. An example WBMS described herein includes two or more primary devices, where each primary device uses its own superframe interval to communicate with only a subset of the battery cells. The example primary devices communicate with one another to ensure their superframe intervals are synchronized in time and maintain a minimum difference from one another in the frequency domain, thereby ensuring the wireless communications between a first primary device and a first subset of battery cells does not interfere with the wireless communications between a second primary device and a second subset of battery cells. By doing so, the example WBMS increases performance by increasing the amount of time per super frame interval assigned to a given battery cell.

An example WBMS described herein also includes a first BQ circuit coupled to a first battery cell and to a primary device through a wired connection, a second BQ circuit coupled to a second battery cell and configurable to wirelessly communicate with the primary device, and a third BQ circuit coupled to both the first battery cell and the second battery cell. The example WBMS enables the three BQ circuits to synchronously perform battery health measurements. In some applications, the example WBMS does so by implementing a just-in-time protocol in which the second BQ circuit performs a measurement upon receipt of wirelessly receiving a message. In other applications, the example WBMS causes synchronized measurements by implementing a schedule protocol in which the second BQ circuit performs a measurement at a scheduled time after the primary device transmits a first message. The scheduled time provides a window for the primary device to transmit a second message to the second BQ circuit in case the second BQ circuit did not receive the first message (due to, for example, packet loss over caused by the wireless medium). In both the just-in-time protocol and the schedule protocol, the example WBMS uses techniques described herein to mitigate or respond to the effects of packet loss over the wireless medium.

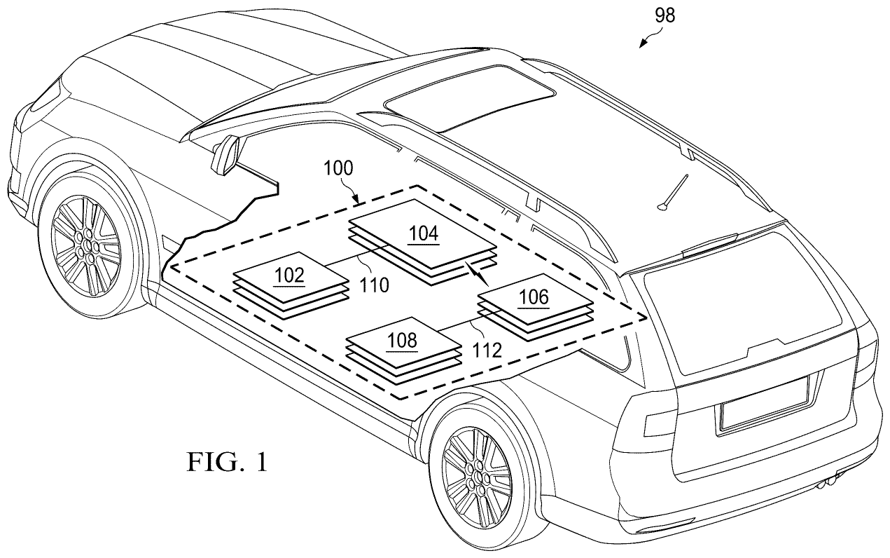

FIG. 1 is a schematic diagram of an automotive system 98 including multiple primary and secondary devices configured to communicate using concurrent superframes. The system 98 may be a vehicle, such as an automobile, a watercraft, an aircraft, a spacecraft, or a military vehicle. The system 98 may also be a non-vehicular system that includes battery cells that are monitored. Further, the system 98 may be any type of system in which information is to be repeatedly communicated between wireless devices. Additional examples of the system 98 may include one or more of the following, in any combination: smartphones; laptop computers; desktop computers; tablets; notebooks; appliances; and entertainment devices. The remainder of this description assumes that the system 98 is an automobile, but the scope of this description is not limited to automobiles or any other particular type of system. Furthermore, although the concurrent superframe scheme is described herein within the context of wireless battery management systems, the teachings of this description may be extended to other types of systems, including home automation, industrial automation, and wireless sensor networks.

The example system 98 includes a wireless battery management system (WBMS) 100. The WBMS 100 may be positioned in any part of the automobile, but in some examples, the WBMS 100 is positioned in, on, or near a bottom part of a chassis of the automobile, such as below one or more seats of the automobile. The WBMS 100 may include one or more battery controller devices 102 that oversees and controls the WBMS 100 (e.g., by load balancing among devices and determining whether to measure current, voltage, temperature, or other register settings of battery cells); one or more primary devices 104 coupled to the battery controller devices 102 by way of one or more wired or wireless connections 110; one or more secondary devices 106; and one or more battery cells 108 coupled to the one or more secondary devices 106 by way of one or more wired or wireless connections 112. The primary devices 104 communicate wirelessly with the secondary devices 106 using a concurrent superframe protocol, as described herein.

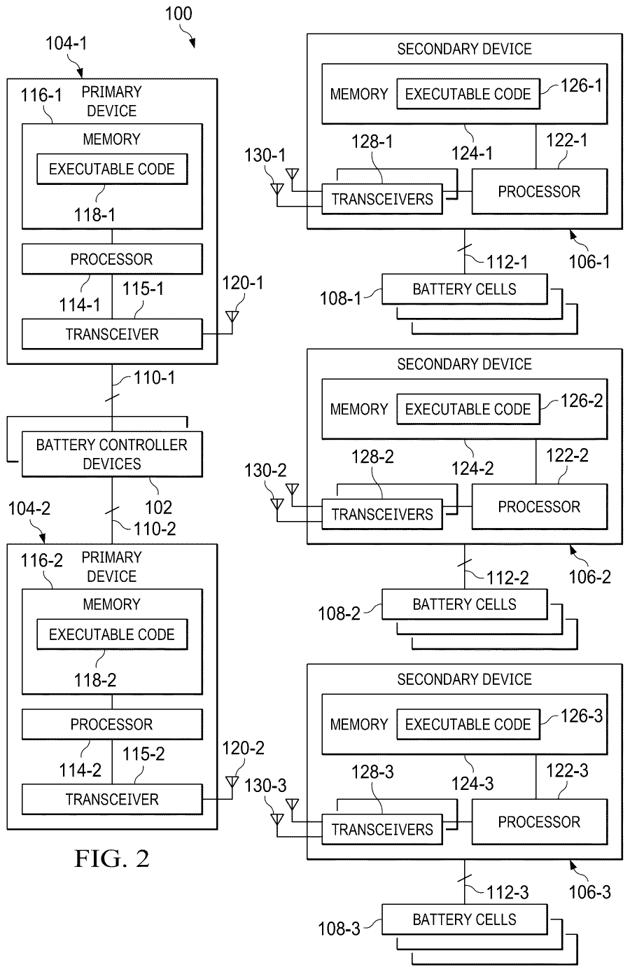

FIG. 2 is a block diagram of the WBMS 100 of FIG. 1. The WBMS 100 may include one or more battery controller devices 102 that are coupled to primary devices 104-1 and 104-2 by way of one or more wired or wireless connections 110-1 and 110-2, respectively. The primary device 104-1 includes processor circuitry 114-1, a transceiver 115-1 coupled to the processor circuitry 114-1, and memory 116-1 (e.g., random access memory (RAM), and read-only memory (ROM)) coupled to the processor circuitry 114-1. The memory 116-1 stores executable code 118-1. The processor circuitry 114-1, upon executing the executable code 118-1, performs some or all of the actions attributed herein to the primary device 104-1 or to the processor circuitry 114-1. An antenna 120-1 is coupled to the transceiver 115-1 and is configured to transmit signals to and receive signals from other devices in the WBMS 100. The primary device 104-2 includes processor circuitry 114-2 coupled to a transceiver 115-2 and memory 116-2 (e.g., RAM or ROM). The memory 116-2 stores executable code 118-2. The processor circuitry 114-2, upon executing the executable code 118-2, performs some or all of the actions attributed herein to the primary device 104-2 or the processor circuitry 114-2. An antenna 120-2 is coupled to the transceiver 115-2 and is configured to transmit signals to and receive signals from other devices in the WBMS 100.

Any processors described herein may be implemented by any type of programmable circuitry. Examples of programmable circuitry include but are not limited to programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs).

Further, any transceivers described herein may use the license-free 2.4 gigahertz (GHz) industrial, scientific, and medical (ISM) band from 2.4 GHz to 2.483 GHz, which is compliant with the Bluetooth Special Interest Group (SIG). Also or alternatively, the transceivers may use 2 megabits per second (Mbps) Bluetooth Low Energy (BLE) across the physical layer (PHY). The Open Systems Interconnection (OSI) model includes the PHY as a layer used for communicating raw bits over a physical medium. In examples described herein, the PHY is free space, which the WBMS 100 uses to wirelessly communicate between the various devices of the WBMS 100. In some examples, the transceivers described herein are instantiated by programmable circuitry executing RF instructions.

A secondary device 106-1 may include a processor 122-1 coupled to a memory 124-1 storing executable code 126-1. The processor 122-1, upon executing the executable code 126-1, may perform some or all of the actions attributed herein to the secondary device 106-1 or the processor 122-1. One or more transceivers 128-1 are coupled to the processor 122-1, and one or more antennas 130-1 are coupled to the one or more transceivers 128-1. The secondary device 106-1 is coupled to one or more battery cells 108-1 by way of one or more connections 112-1.

A secondary device 106-2 may include a processor 122-2 coupled to a memory 124-2 storing executable code 126-2. The processor 122-2, upon executing the executable code 126-2, may perform some or all of the actions attributed herein to the secondary device 106-2 or the processor 122-2. One or more transceivers 128-2 are coupled to the processor 122-2, and one or more antennas 130-2 are coupled to the one or more transceivers 128-2. The secondary device 106-2 is coupled to one or more battery cells 108-2 by way of one or more connections 112-2.

A secondary device 106-3 may include a processor 122-3 coupled to a memory 124-3 storing executable code 126-3. The processor 122-3, upon executing the executable code 126-3, may perform some or all of the actions attributed herein to the secondary device 106-3 or the processor 122-3. One or more transceivers 128-3 are coupled to the processor 122-3, and one or more antennas 130-3 are coupled to the one or more transceivers 128-3. The secondary device 106-3 is coupled to one or more battery cells 108-3 by way of one or more connections 112-3.

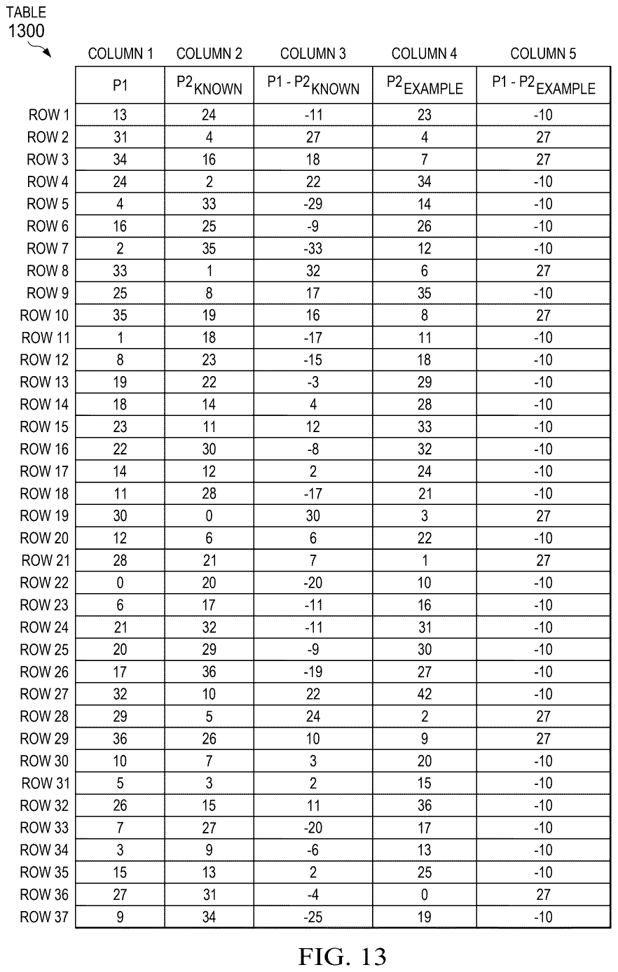

The primary devices 104-1, 104-2 of FIG. 2 may be collectively referred to herein as primary devices 104. Similarly, the secondary devices 106-1, 106-2, 106-3 may be collectively referred to herein as secondary devices 106, and so on. A similar convention may be used for any or all of the features depicted in the drawings. In some examples, one or more of the primary devices 104 are instantiated by programmable circuitry executing primary instructions to perform operations such as those represented by the flowchart(s) of FIGS. 14-20. In some examples, one or more of the secondary devices 106 are instantiated by programmable circuitry executing secondary instructions to perform operations such as those represented by the flowchart(s) of FIG. 14-20.

The primary and secondary devices described herein (e.g., primary devices 104, secondary devices 106) may be implemented as a CC2662 or a BQ79616 made by TEXAS INSTRUMENTS INC.® of Dallas, TX. Additional example details of the CC2662 and BW79616 can be found in the datasheet entitled “CC2662R-Q1 SimpleLink™ Wireless BMS MCU,” revised July 2023, available at https://www.ti.com/product/CC2662R-Q1, and the datasheet entitled “BQ79616-Q1, BQ79614-Q1, BQ79612-Q1 Functional Safety-Compliant Automotive 16S/14S/12S Battery Monitor, Balancer and Integrated Hardware Protector,” revised September 2022, available at https://www.ti.com/product/BQ79616-Q1, each of which is incorporated by reference in its entirety. As just one example, a secondary device 106 may be implemented as CC2662 for communication coupled to a BQ79616 for battery monitoring. Additional examples of WBMS architecture and communication can be found in commonly assigned U.S. Application Publication No. 2025/0008491, entitled “Hierarchical Wireless Battery Management System” filed Jun. 30, 2023, and commonly assigned U.S. application Ser. No. 18/647,353, entitled “Scheduling for Multiple Primary Nodes,” filed Apr. 26, 2024, each of which is hereby incorporated herein by reference in its entirety.

The secondary devices 106 are configured to monitor the status of respective battery cells 108 (e.g., the voltage being provided by the battery cells 108, the temperatures of battery cells 108). For example, a given secondary device 106-1 may include, or be coupled to, or communicate, with one or more sensors configured to measure a variety of parameters associated with the corresponding battery cells 108-1. The sensors may relay the sensed data to the processors 122 of the secondary devices 106 by way of a universal asynchronous receiver/transmitter (UART) protocol or any other suitable protocol. Further, a given secondary device 106-1 may be configured to communicate with one or both of the primary devices 104. For example, the secondary device 106-1 may communicate with the primary device 104-1 during one slot of a superframe, and the secondary device 106-1 may communicate with the primary device 104-2 during a different slot of the superframe. Alternatively, the secondary device 106-1 may communicate with both primary devices 104 simultaneously using different transceivers 128-1. The secondary devices 106-2 and 1006-3 may communicate with both primary devices 104 similarly to the secondary device 106-1. In some examples, a given secondary devices 106-1 is configured to communicate with one or more of the remaining secondary devices 106-2, 106-3. The primary devices 104 also may communicate with the secondary devices 106 and with one other. For example, the primary device 104-1 may transmit data to one or more of the primary device 104-2, the secondary device 106-1, the secondary device 106-2, or the secondary device 106-3. The primary device 104-2 may operate similarly as the primary device 104-1. The communications that are transmitted by the primary devices 104 may be received from one or more of the battery controller devices 102. Similarly, the communications that are received by the primary devices 104 may be provided to one or more of the battery controller devices 102.

The WBMS 100 as depicted in FIG. 2 is illustrative. In some examples, the WBMS 100 may include any number of primary devices, secondary devices, battery controllers, battery cells, other components, and wired or wireless connections between one or more of the foregoing. Any and all such variations are contemplated and included in the scope of this description.

Additional examples of the components shown in FIGS. 1 and 2 can be found in commonly assigned U.S. Application Publication No. 2024/0069110, entitled “Multiple Primary Nodes for Wireless Battery Management System Robustness,” filed Aug. 30, 2022, and is hereby incorporated herein by reference in its entirety.

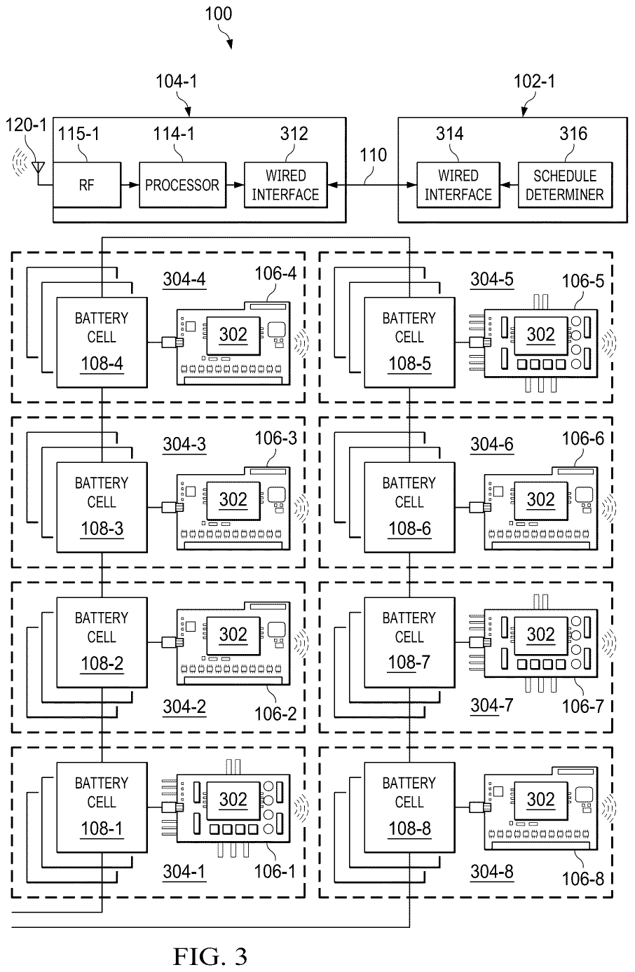

FIG. 3 is a block diagram of an implementation of the WBMS 100 of FIG. 1. The WBMS 100 of FIG. 3 is configured to operate based on the concurrent superframe scheme as described further in FIGS. 7A and 7B. The WBMS 100 of FIG. 3 may be instantiated (e.g., creating an instance of, bring into being for any length of time, materialize, implement, etc.) by programmable circuitry such as a CPU executing first instructions. Also or alternatively, the WBMS 100 of FIG. 3 may be instantiated by (i) an ASIC or (ii) a FPGA structured or configured in response to execution of second instructions to perform operations corresponding to the first instructions. Some or all of the circuitry of FIG. 3 may, thus, be instantiated at the same or different times. Some or all of the circuitry of FIG. 3 may be instantiated, for example, in one or more threads executing concurrently on hardware or in series on hardware. Moreover, in some examples, some or all of the circuitry of FIG. 3 may be implemented by microprocessor circuitry executing instructions or FPGA circuitry performing operations to implement one or more virtual machines or containers.

The example block diagram of FIG. 3 includes the battery controller device 102-1, the primary device 104-1, secondary devices 106-1 through 106-8, and battery cells 108-1 through 108-8. The primary device 104-1 includes the antenna 120-1, radio frequency (RF) transceiver 115-1, the processor circuitry 114-1 of FIG. 1, and example wired interface circuitry 312. The battery controller device 102-1 includes example wired interface circuitry 314 and example schedule determiner circuitry 316.

In the example of FIG. 3, the respective secondary devices 106 include schedule requester circuitry 302. As used herein, a secondary device 106-1 and its corresponding battery cell(s) 108-1 may be collectively referred to as a battery module 304-1. Accordingly, the battery modules 304-1 through 304-8 collectively form battery modules 304.

The scope of this description is not limited to any particular number of each type of device illustrated in FIG. 3. Accordingly, the WBMS 100 of FIG. 3 may include any number of battery controller devices 102, primary devices 104, or battery modules 304. In some examples, the WBMS 100 includes two or more battery controller devices 102, where a first set of the secondary devices 106 are assigned to communicate with a first battery controller device 102-1, and a second set of the secondary devices 106 are assigned to communicate with a second battery controller device 102-2. The first and second sets of secondary devices may or may not overlap.

Within the primary device 104-1, the wired interface circuitry 312 sends and receives communications with the battery controller device 102-1 via the wired connection 110. The wired interface circuitry 312 may implement any suitable hardware components, including but not limited to terminals, pins, interconnects, etc., to implement wired communications. Similarly, within the battery controller device 102-1, the wired interface circuitry 314 sends and receives communications with the primary device 104 via the wired connection 110. The wired interface circuitry 314 may implement any suitable hardware components to implement wired communications. In examples, the wired interface circuitry 312, 314 may be replaced by transceivers or other circuitry suitable to facilitate wireless communications between the primary device 104 and the battery controller device 102-1.

The schedule determiner circuitry 316 determines different communication schedules for different superframes. The schedule determiner circuitry 316 adjusts a schedule or creates new schedules for superframes based on the transmission request transmitted by the multiple instances of the schedule requester circuitry 302. In the example of FIG. 3, the schedule determiner circuitry 316 is implemented within the battery controller device 102-1. In other examples, the schedule determiner circuitry 316 is implemented within the primary device 104 or elsewhere within the WBMS 100. In some examples, the schedule determiner circuitry 316 is instantiated by programmable circuitry executing schedule determiner instructions.

The battery modules 304 wirelessly communicate with the primary device 104-1 using concurrent superframes. Accordingly, a first superframe containing a first set of communications occurs at the same time as a second superframe containing a second set of communications. Within a given battery module 304-1, the schedule requester circuitry 302 determines whether a transmission regarding the corresponding battery cell 108-1 is made in an upcoming set of concurrent superframes. The schedule requester circuitry 302 may determine when to schedule a given transmission based on factors that include status and performance of the corresponding battery cell 108-1.

The schedule requester circuitry 302 optionally requests to be included on a schedule for an upcoming superframe based on the result of the determination. Accordingly, the battery modules 304 do not request a transmission in an upcoming superframe every time an opportunity to request is available. The schedule requester circuitry 302 may provide additional information to the battery controller device 102-1 when requesting a transmission in an upcoming superframe. The schedule requester circuitry 302 may also request a specific number of requested time slots, request a specific duration of uplink time, or request a specific data size to uplink (e.g., a specific number of blocks, bytes, or bits), etc. Alternatively, the request sent by the schedule requester circuitry 302 may indicate only that a corresponding battery module 304-1 is requesting more time for transmission, without any specifics about the requested time duration, number of time slots, or uplink size.

In the example of FIG. 3, each instance of the schedule requester circuitry 302 is implemented within the secondary devices 106. In other examples, one or more instances of the schedule requester circuitry 302 are implemented elsewhere within the respective battery modules 304. In some examples, the schedule requester circuitry 302 is instantiated by programmable circuitry executing schedule requester instructions.

The battery modules 304 are heterogeneous in the sense that the design, manufacture, capabilities, or performance of a first battery module may differ from that of a second battery module. For example, in FIG. 3, battery cells 108-1, 108-2, 108-4 store a larger amount of charge than battery cells 108-3, 108-5-108-8. Furthermore, the amount of charge stored in battery cells 108-1, 108-2, 108-4 is nonuniform. In an additional example, FIG. 3 illustrates the secondary devices 106-1, 106-5, 106-7 implemented by a first type of programmable circuitry, and secondary devices 106-2-106-4, 106-6, 106-8 implemented by a different type of programmable circuitry. While the example FIG. 3 illustrates variance in battery capacity and type of programmable circuitry, in practice, the battery modules 304 may include other types of differences.

In some examples, the heterogeneity of the WBMS 100 causes some battery modules to seek communication with the battery controller device 102-1 more frequently than other battery modules. Some battery modules may also or alternatively transmit different types of information within a superframe than other battery modules. For example, the battery module 304-1 may seek to report a storage capacity measurement when the battery module 304-2 seeks to report an error code. The battery controller device 102-1 enables such diverse forms of communication by receiving requests for transmissions sent by the battery modules 304 and determining a schedule for each superframe. Such techniques are described in commonly assigned U.S. Application Publication No. 2025/0039859, entitled “Methods and Apparatus to Determine Communication Schedules for Wireless Battery Systems,” filed Jul. 28, 2023, which is hereby incorporated herein by reference in its entirety.

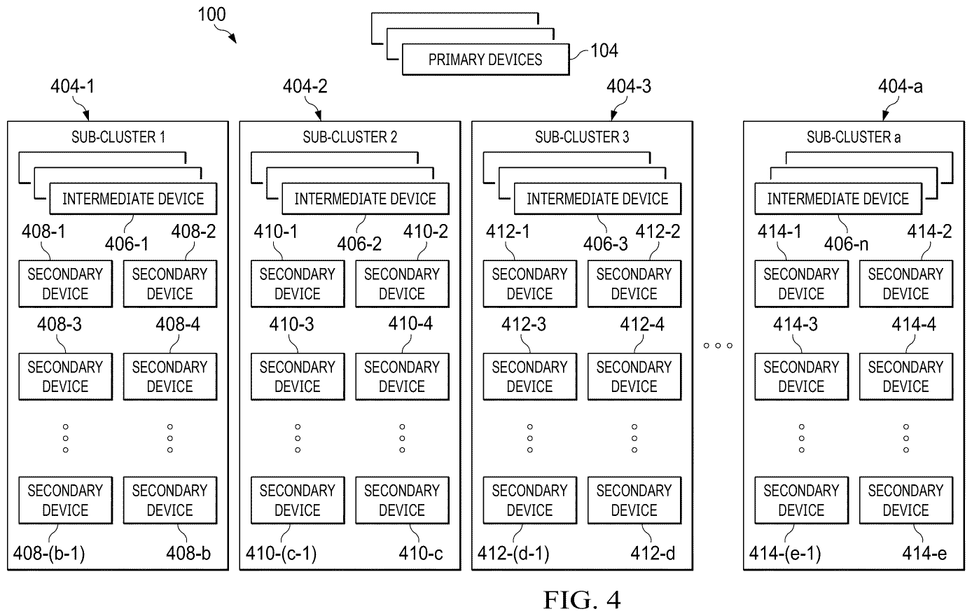

FIG. 4 is a block diagram of another implementation of the WBMS 100 of FIG. 1. The architecture of the WBMS 100 in the example of FIG. 4 includes a layer of intermediate devices between the primary and secondary devices, thus facilitating scale in especially large or complex systems. The example of FIG. 4 includes one or more primary devices 104 and multiple sub-clusters 404-1 through 404-n (collectively referred to herein as sub-clusters 404).

The sub-cluster 404-1 includes one or more intermediate devices 406-1 and multiple secondary devices 408-1 through 408-b (collectively referred to herein as secondary devices 408). The sub-cluster 404-2 includes one or more intermediate devices 406-2 and multiple secondary devices 410-1 through 410-c (collectively referred to herein as secondary devices 410). The sub-cluster 404-3 includes one or more intermediate devices 406-3 and multiple secondary devices 412-1 through 412-d (collectively referred to herein as secondary devices 412). The sub-cluster 404-a includes one or more intermediate devices 406-n and multiple secondary devices 414-1 through 414-e (collectively referred to herein as secondary devices 414). While the letters a, b, c, d, and e are used in FIG. 4 to indicate a plurality of reference numerals, the size of a given plurality need not be equal to the size of any other plurality. For example, in FIG. 4, the number of secondary devices 408 may be the same or different than the number of secondary devices 410, 412, or 414, the number of sub-clusters 404 may be the same or different than the number of secondary devices 408, 410, 412, or 414, etc.

In operation, the secondary devices shown in FIG. 4 collects data, such as the battery cell status data described above, and provides the data to a corresponding intermediate device 406. For example, each of the secondary devices 408 collects data and transmits the data to first and second intermediate devices 406-1. These transmissions occur according to the concurrent superframe scheme described herein, such as with reference to FIGS. 7A and 7B. Thus, for instance, the first and second intermediate devices 406-1 may broadcast downlink synchronization information during first and second slots of concurrent superframes. The secondary devices 408 may receive the broadcast information and use the broadcast information to synchronize communications with the first and second intermediate devices 406-1. Thereafter, during the concurrent superframes, each of the secondary devices 408 may transmit its respective data twice, once in one slot to the first intermediate device 406-1, and again in another slot to the second intermediate device 406-1, with both transmissions occurring on different frequencies. In this way, the first and second intermediate devices 406-1 are substantially likely to receive at least one instance of the data from each of the secondary devices 408. Each of the sub-clusters 404 operates in a similar manner.

After the intermediate devices 406 of each sub-cluster 404 has received the data from respective secondary devices, the intermediate devices 406 transmit the data to the primary devices 104 using the concurrent superframe scheme described herein. For example, in first and second slots of concurrent superframes, first and second primary devices 104 may broadcast downlink synchronization information to the intermediate devices 406, which the intermediate devices 406 may use to synchronize communications with the first and second primary devices 104. Thereafter, during the concurrent superframes, each of the intermediate devices 406 may transmit respective data twice, once in one slot to the first primary device 104, and again in another slot to the second primary device 104, with both transmissions possibly occurring on different frequencies. In this way, the first and second primary devices 104 are substantially likely to receive at least one instance of the data from each of the intermediate devices 406. The concurrent superframe scheme described herein may be scaled to any number of wireless devices in a WBMS, or any other system besides a WBMS in which robust wireless communications are useful. For example, three or more primary devices 104 may be used, in which case a given intermediate device 406 may transmit the same data to the three or more primary devices 104 during different slots and on different frequencies. In some examples in which three or more primary devices 104 may be used, a first intermediate device 406 may transmit data to first and second primary devices 104 in different slots and on different frequencies, while a second intermediate device 406 transmits different data to second and third primary devices 104 in different slots and on different frequencies. Furthermore, the concepts described herein may be extended to any number of concurrent superframes.

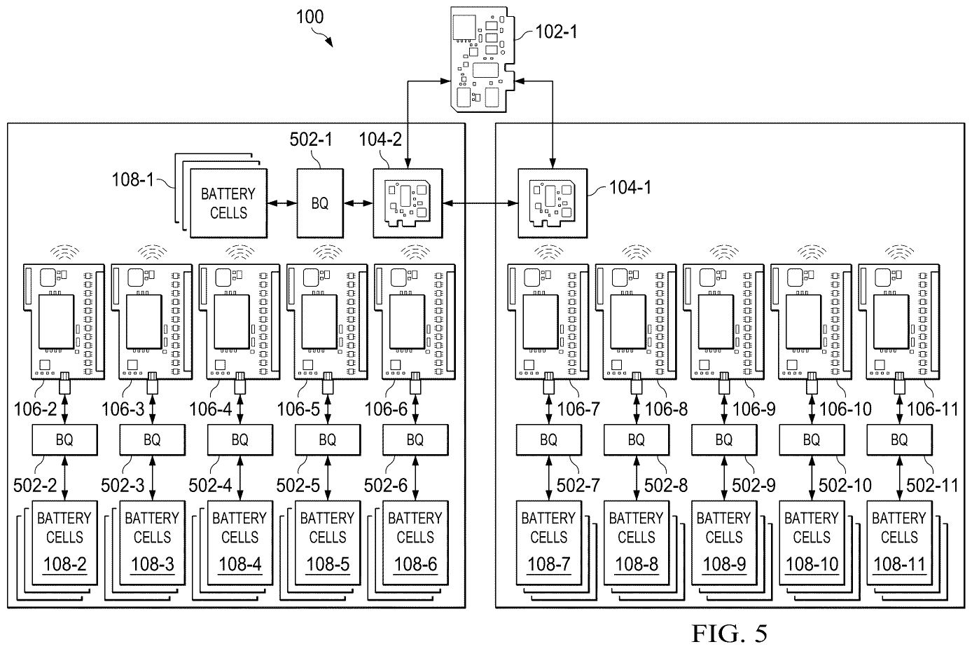

FIG. 5 is a block diagram of an implementation of the WBMS 100 of FIG. 1. The example of FIG. 5 includes one battery controller device 102-1, two primary devices 104, eleven secondary devices 106, and eleven battery cells 108 as described above in one or more of FIGS. 1-4. FIG. 5 also includes example BQ circuits 502-1 through 502-11 (collectively referred to as BQ circuits 502). The scope of this description is not limited to any particular number of each type of device illustrated in the example of FIG. 5.

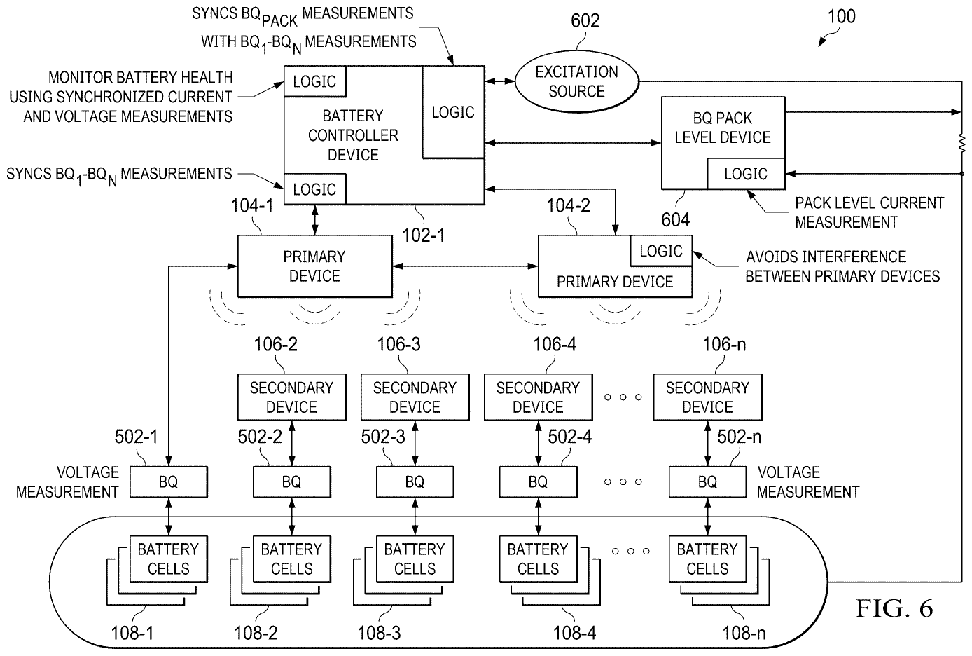

A given BQ circuit 502-1 is configured to monitor the quality, status, and health of its respective battery cells 108-1. For example, Electrochemical Impedance Spectroscopy (EIS) refers to certain techniques that measure the health of a battery cell. Within the set of operations performed across the WBMS 100 to implement EIS, a given BQ circuit 502-1 measures the voltages across the corresponding battery cells 108-1. As part of the EIS technique, the WBMS 100 aims to perform battery measurements synchronously. For example, the BQ circuit 502-1 preferably measures voltage across all of the battery cells 108-1 at the same time that the BQ circuit 502-2 measures voltages across all of the battery cells 108-2. EIS is described further in connection with at least FIG. 6. In some examples, a given BQ circuit is referred to as a BQ chip.

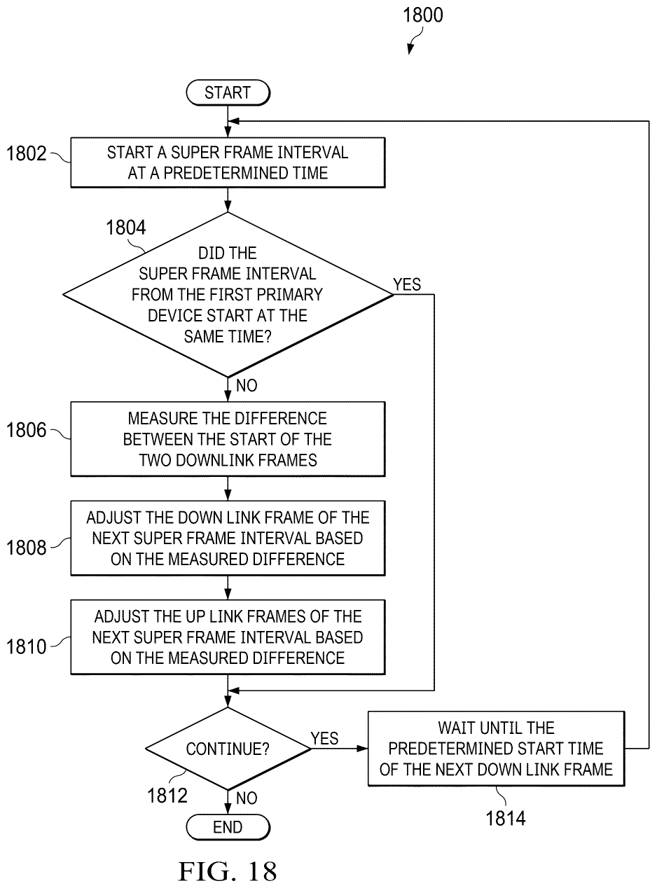

The BQ circuits 502 may perform additional operations to monitor the quality, status, or health of the battery cells. Such additional operations include but are not limited to temperature measurements. In some examples, the BQ circuits 502 are referred to as module-level circuits because there is one BQ circuit 502-1 per module 304-1 (or per group of battery cells 108-1) as described in FIG. 3. In some examples, a given BQ circuit 502-1 is referred to as a monitor circuit. As used above and herein, the terms “quality”, “status”, and “health” may be used interchangeably when referring to the monitoring operations performed by the BQ circuits 502. The BQ circuits 502 may be implemented by any type of programmable circuitry. In some examples, the BQ circuits 502 are instantiated by programmable circuitry executing module-level BQ instructions to perform operations such as those represented by the flowchart(s) of FIG. 19.

The BQ circuits 502 may be implemented in a wide variety of architectures. In the example of FIG. 3, the functionality of the BQ circuits 502 is implemented within the secondary devices 106 as described above. In the example of FIG. 5, the BQ circuits 502 are implemented as a separate, standalone device. The BQ circuits 502-2 through 502-11 communicate with their respective primary devices 104 using the secondary devices 106-2 through 106-11, which act as intermediate devices. Accordingly, the BQ circuits 502-2 through 502-11 are wirelessly connected to the primary devices 104. However, the BQ circuit 502-1 is directly coupled (without an intermediate device) to the primary device 104-2 over a wired connection. Thus, the example of FIG. 5 shows a hybrid battery system that includes communication over both wireless and wired connections. Known WBMSs do not support EIS techniques in such a hybrid battery system because the difference in communication latency between the wired and wireless transmission mediums conflict with the goal of all BQ circuits 502 recording voltage measurements at the same time. Advantageously, the techniques described in the examples herein overcome these conflicts to support EIS operations within hybrid battery systems.

The example of FIG. 5 also shows an environment where, like FIG. 4, the large number of secondary devices 106 and battery cells 108 drives a need for multiple primary devices 104-1 and 104-2. In this example, the secondary devices 106-7 through 106-11 communicate wirelessly with the primary device 104-1 while the secondary devices 106-2 through 106-6 communicate wirelessly with the primary device 104-2.

In general, WBMS protocols have strict performance requirements that are difficult to meet with more than one primary device. For example, some WBMS protocols include a bandwidth of approximately 600 kbps or greater, data latency of approximately 100 milliseconds or less, a packet error rate of approximately 10-5 or less, and power consumptions of less than approximately 1 milliampere (mA) at the primary devices 104 and less than approximately 300 microamperes (μA) at the secondary devices 106. In some examples, the primary devices 104-1 and 104-2 run with independent clocks, which can cause a super frame interval of the primary device 104-2 to be behind or ahead in time relative to a super frame interval of the primary device 104-1.

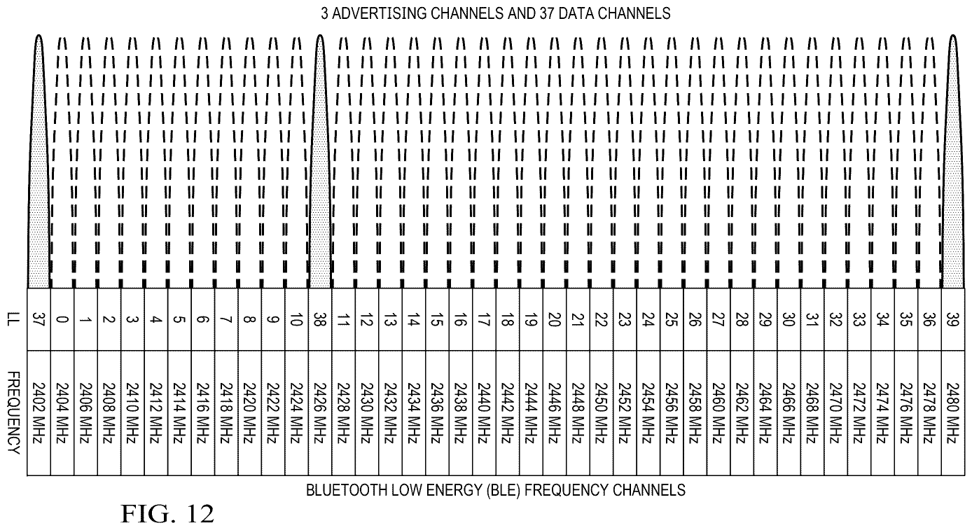

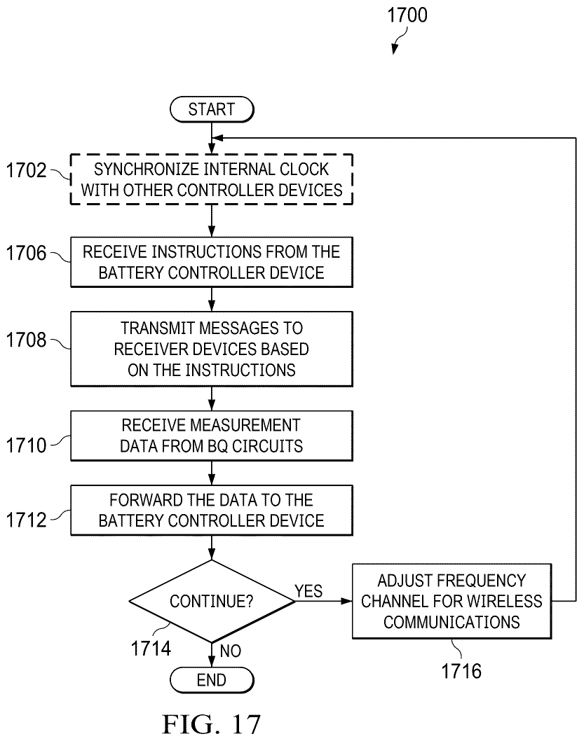

In the intra-network interference perspective, three challenges are addressed. First, the primary devices 104 within a given implementation of the WBMS 100 (e.g., 104-1 and 104-2 in FIG. 5) are preferably synchronized in time. Second, the concurrent superframes of the primary devices 104 preferably do not overlap in frequency. Third, the primary devices 104 are preferably able to start operation at the same time based on the command from a host device. The techniques of this description may address at least the first and second challenges. Such techniques are described further in at least FIGS. 13 and 18.

FIG. 6 is a block diagram of an implementation of the WBMS 100 of FIG. 1. The WBMS of FIG. 6 may be instantiated (e.g., creating an instance of, bring into being for any length of time, materialize, implement, etc.) by programmable circuitry such as a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Also or alternatively, the WBMS of FIG. 6 may be instantiated (e.g., creating an instance of, bring into being for any length of time, materialize, implement, etc.) by (i) an Application Specific Integrated Circuit (ASIC) or (ii) a Field Programmable Gate Array (FPGA) structured or configured in response to execution of second instructions to perform operations corresponding to the first instructions. Some or all of the circuitry of FIG. 6 may, thus, be instantiated at the same or different times. Some or all of the circuitry of FIG. 6 may be instantiated, for example, in one or more threads executing concurrently on hardware or in series on hardware. Moreover, in some examples, some or all of the circuitry of FIG. 6 may be implemented by microprocessor circuitry executing instructions or FPGA circuitry performing operations to implement one or more virtual machines or containers.

The example of FIG. 6 includes one battery controller device 102-1, two primary devices 104, (n−1) secondary devices 106, n battery cells 108, and n BQ circuits 502 as described above in one or more of FIGS. 1-5. FIG. 5 also includes an example excitation source 602 and a BQ pack-level device 604. The scope of this description is not limited to any particular number of each type of device illustrated in the example of FIG. 5.

Like FIG. 5, the example of FIG. 6 shows a hybrid battery system that supports EIS operations. In the example of FIG. 6, the battery controller device 102-1 manages the EIS measurements and performs the subsequent analysis of the EIS measurements. More generally, the battery controller 102-1 is responsible for the monitoring and regulating the health of the WBMS 100. Thus, as described further below, the battery controller device 102-1 includes logic to at least: synchronize the measurements of the BQ circuits 502 to one another in time, synchronize measurements from the BQ pack-level device 604 in time with measurements from the BQ circuits 502, determine when the EIS measurements occur, and monitor battery health using the synchronized current and voltage measurements. In other examples, one or more portions of the foregoing logic are distributed across any number of devices containing programmable circuitry (e.g., including but not limited to the primary devices 104). For example, the WBMS 100 may be implemented without a battery controller device 102-1 where primary device 104-1 and/or 104-2 is configurable to perform the operations ascribed to battery controller device 102-1 herein. In some examples, the battery controller device 102-1 is instantiated by programmable circuitry executing battery controller instructions to perform operations such as those represented by the flowchart(s) of FIGS. 14-16.

In general, EIS refers to techniques that analyze how a battery responds to an AC signal. The excitation source 602 generates this AC signal based on instructions from the battery controller device 102. In some examples, the AC signal may correspond to multiple pulses over a range of frequencies. Devices within the WBMS 100 then measure the impedance of the battery cells 108 based on their response to the AC signal. In the example of FIG. 6, impedance is measured using both module-level voltage measurements from the BQ circuits 502 and from pack-level current measurements from the BQ pack-level device 604. As used above and herein, a “pack” refers to all battery cells 108 within a given WBMS 100.

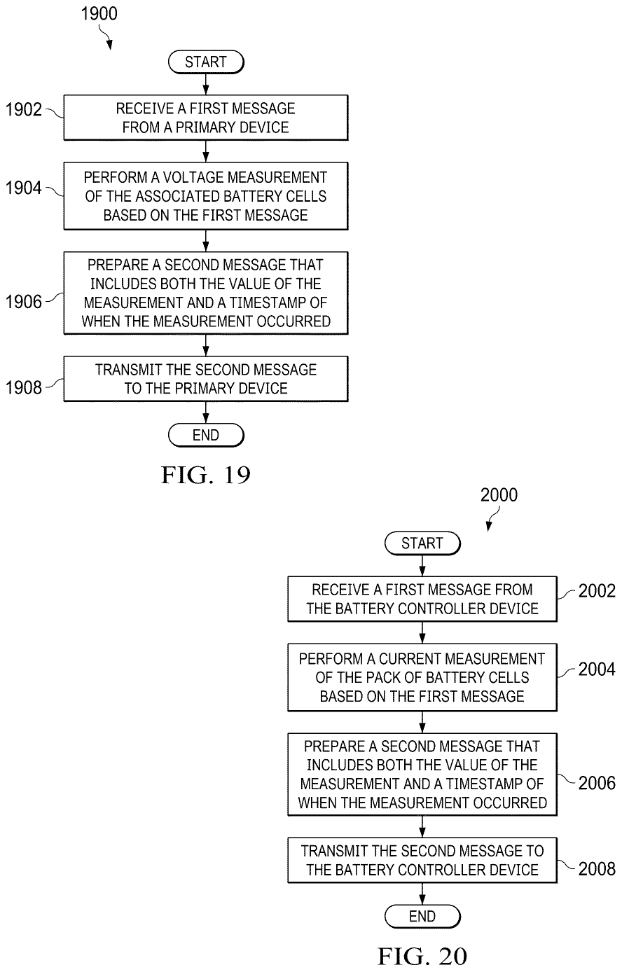

The BQ pack-level device 604 measures the current flowing through the pack of battery cells 108 as described above. In some examples, the BQ pack-level device 604 is referred to as a monitor circuit. The BQ pack-level device 604 may be implemented by any type of programmable circuitry. In some examples, the BQ pack-level device 604 is instantiated by programmable circuitry executing BQ pack-level instructions to perform operations such as those represented by the flowchart(s) of FIG. 20.

In this example, the BQ pack-level device 604 is directly coupled (without an intermediate device) to the battery controller device 102-1 over a wired connection. Thus, the example of FIG. 6 shows a hybrid battery system in the sense that some monitor circuits (502-1 and 604) communicate with the battery controller device 102-1 exclusively over wired mediums while other monitor circuits (502-2 through 502-n) communicate with the battery controller device 102-1 over a wireless medium. In other examples, the BQ pack-level device 604 is coupled to the battery controller device 102-1 over a wireless medium. In other examples, the WBMS 100 does not include the excitation source 602 or the BQ pack-level device 604.

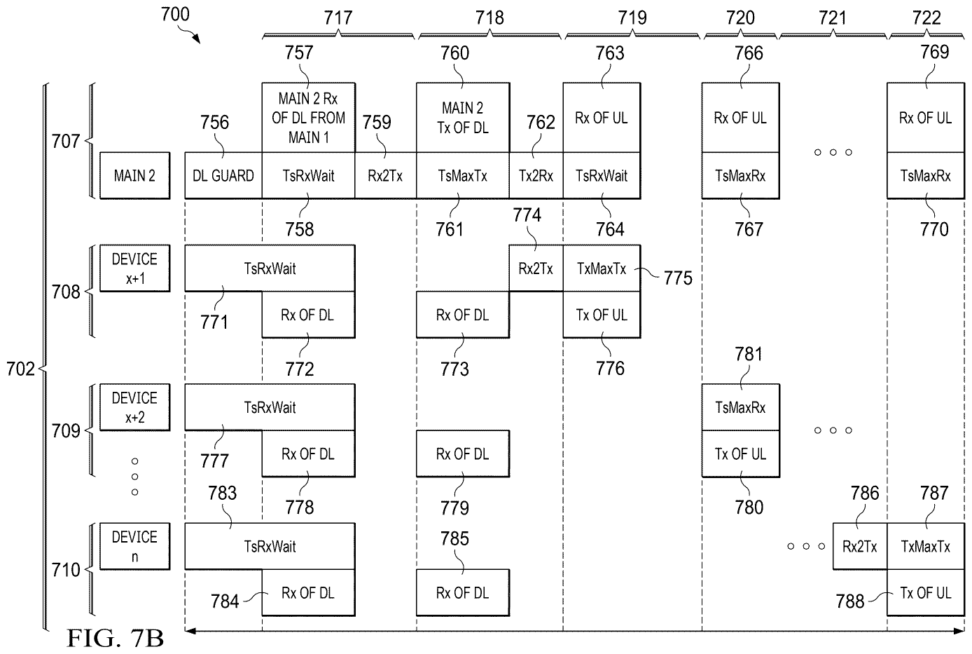

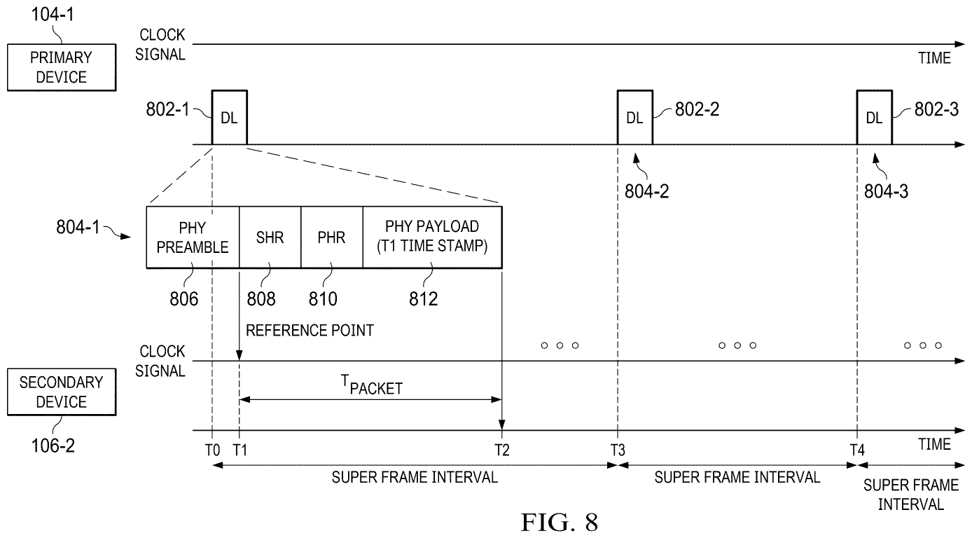

Notably, EIS techniques preferably use synchronized measurements from all monitor circuits within a WBMS. Thus, by achieving such timing synchronization, the examples described herein overcome both a) the latency differences between wired and wireless communications described above and b) the latency differences caused by forwarding messages through different number of intermediate devices (e.g., in FIG. 6 there are no intermediate devices between the battery controller device 102-1 and the BQ pack-level device 604, one intermediate device between the battery controller device 102-1 and the BQ circuit 502-1, and two intermediate devices between the battery controller device 102-1 and the BQ circuit 502-2). Measurements that are synchronized in time (e.g., concurrent measurements) provide a snapshot of the battery status across multiple sensors, which can aid in complying with applicable safety requirements. Techniques to implement such timing synchronization are described further in connection with FIGS. 8-9B.

Like FIG. 5, the example of FIG. 6 also shows an implementation of the WBMS 100 that includes two primary devices 104. In this example, the primary device 104-1 communicates to the BQ circuit 502-1 through a wired medium and communicates wirelessly with the secondary devices 106-2 through 106-x where (x is a natural number greater than 4 but less than n), while the primary device 104-2 communicates wirelessly with the secondary devices 106-(x+1) through 106-n.

Implementing multiple primary devices 104 within a WBMS enables the exchange of multiple concurrent superframe intervals across the wireless medium. The concurrent superframe intervals for primary devices 104-1 and 104-2 are described further in connection with FIGS. 7A and 7B respectively. Concurrent superframes enable more time to be assigned to a given set of battery cells 108-1 per superframe interval than use cases where all n sets of battery cells 108 shared a single super frame interval, thereby improving performance and scalability as described above. However, if the concurrent superframes interfere with one another, performance of the WBMS 100 can decrease due to increased transmission delays, data corruption from which the underlying information may or may not be recoverable, etc.

In the example of FIG. 6, the primary device 104-2 includes logic described herein that enables the primary device 104-2 to avoid interference with the primary device 104-1. For example, the primary device 104-2 determines the timing of its superframe intervals so that the superframes begin, end, and transition between intermediate phases at the same time (e.g., synchronously) as the superframes from the primary device 104-1 begin, end, and transition between intermediate phases. The primary device 104-2 also implements a channel hopping scheme that ensures wireless communications sent to or from the primary device 104-2 maintain at least a minimum difference in frequency from wireless communications sent to or from the primary device 104-1. More generally, the examples described herein enable any number of primary devices 104 within a WBMS to avoid interference with one another, where all but one of the primary devices determine their superframe timing and/or channel hopping technique based on the remaining primary device (whose superframe timing and channel hopping sequence are independent of the other primary devices). Techniques for a given primary device 104-2 to determine its superframe interval timing and channel hopping sequence based on another primary device 104-1 are described further in connection with FIGS. 13 and 18.

FIGS. 7A and 7B depict a timing diagram 700 illustrating a concurrent superframe communication protocol which may be implemented by the WBMS 100 in one or more of the example implementations of FIGS. 1-6. Specifically, the timing diagram 700 includes a superframe 701 (shown on FIG. 7A) and a separate superframe 702 (shown on FIG. 7B) that occur concurrently during a single superframe interval. Each superframe includes multiple slots during which various devices in the WBMS 100 may transmit or receive data using Time Division Multiple Access (TDMA) techniques. For example, the superframe 701 includes slots 711-716, and the superframe 702 includes slots 717-722. Because the superframes 701 and 702 are concurrent superframes, each of the slots 711-716 occurs concurrently with a respective slot 717-722, as shown.

Superframe 701 describes the behavior of devices 703-706. In the example shown, device 703 may be the primary device 104-1 as shown in FIG. 6. The remaining devices 704-706 may be the secondary devices 106-2 through 106-x as described above in reference to FIG. 6. For ease of description, FIGS. 7A-7B label devices 703-706 as “main 1,” “device 2,” “device 3,” and “device x,” respectively. Superframe 702 describes the behavior of devices 707-710. In the example shown, device 707 may be the primary device 104-2 as shown in FIG. 6. The remaining devices 708, 709, and 710 may be the secondary devices 106-(x+1) through 106-n. For ease of description, FIGS. 7A and 7B label devices 707, 708, 709, and 710 as “main 2,” “device x+1,” “device x+2,” and “device n,” respectively.

In other examples, the devices 703-710 of FIGS. 7A and 7B refer to a different combination of primary devices 104 and secondary devices 106. In some such examples, a given secondary device may communicate with multiple primary devices 104 on concurrent superframe intervals or switch from a first primary device 104-1 to a second primary device 104-2 between consecutive superframe intervals. Such a secondary device may communicate with multiple primary devices 104 over multiple time slots to mitigate the risk of data loss through data retransmission.

Prior to the first slots 711 and 717, the superframes 701 and 702 enable Down Link (DL) guard transmission periods 723 and 756, respectively, which are useful to mitigate the risk of interference with other superframes that occurred prior to the superframes 701 and 702. At the time of the DL guard transmission periods 723 and 756, the secondary devices 704-706 and 708-710 enter receive modes 738, 744, 750, 771, 777, and 784 (TsRxWait), respectively, which means these secondary devices 704-706 and 708-710 are ready to receive transmissions from other device(s).

After the DL guard transmission periods 723 and 756 have expired, concurrent slots 711 and 717 begin. In slot 711, the primary device 703 (e.g., Main 1) broadcasts data 724 to the other devices 704-710. For example, the primary device 104-1 may broadcast data to the primary device 104-2 and to one or more of the secondary devices 106 during slots 711 and 717. The data broadcast by the primary device 703 may include synchronization information that the receiving devices may use to synchronize their clocks with a clock of the primary device 703. For example, the data broadcast by the primary device 703 may include timestamp data that the receiving devices may use to synchronize their clocks with the clock of the primary device 703. The data broadcast by the primary device 703 may be referred to herein as downlinks. Numeral 725 indicates that, during transmission, the primary device 703 is in a transmission mode (TsMaxTx). At the same time, the secondary 704-706 and 708-710 are in receive modes 738, 744, 750, 771, 777, and 784, respectively (TsRxWait), and the primary device 707 (e.g., Main 2) is in a receive mode 758. During slots 711 and 717, the primary device 703 switches from a transmit mode to a receive mode, as numeral 726 indicates (Tx2Rx). Similarly, during slots 711 and 717, the primary device 707 switches from a receive mode to a transmit mode, as numeral 759 indicates (Rx2Tx). The secondary devices 704-706 and 708-710 remain in their receive modes.

Slots 712 and 718 occur concurrently following slots 711 and 717. During slots 712 and 718, the primary device 707 broadcasts data 760 to the remaining devices 703-706 and 708-710. The broadcast data may be similar to the synchronization data described above with respect to slots 711 and 717. During transmission of the data 760, the primary device 707 is in a transmission mode 761 (TsMaxTx), while the primary device 703 is in a receive mode 728. The secondary devices 704-706 and 708-710 are also in receive modes at this time. Accordingly, the primary device 703 and secondary devices 704-706 and 708-710 receive the data 760 broadcast by the primary device 707. For example, primary device 104-2 may broadcast synchronization data to the primary device 104-1 and to one or more of the secondary devices 106. After transmission and receptions are complete in slots 712 and 718, the primary device 707 switches from a transmit mode to a receive mode as numeral 762 indicates (Tx2Rx), and secondary devices 704 and 708 switch from receive modes to transmit modes, as numerals 741 and 774 indicate (Rx2Tx).

Synchronization is complete in the example of FIGS. 7A and 7B after slots 712 and 718. Slots 713 and 719 occur concurrently following slots 712 and 718. During slots 713 and 719, multiple secondary devices simultaneously transmit data (e.g., status information collected from any of the battery cells 108) to different primary devices 703, 707. For example, secondary device 704 may transmit data 743 to primary device 703, and, at the same time, secondary device 708 may transmit data 776 to primary device 707. To enable such transmissions, secondary device 704 is in transmit mode 742 (TsMaxTx), and secondary device 708 is in transmit mode 775 (TsMaxTx). To facilitate receptions of the transmitted data, primary device 703 is in receive mode 731 (TsRxWait) and primary device 707 is in receive mode 764 (TsRxWait). The data broadcast by secondary devices to primary devices may be referred to herein as uplinks.

Slots 714 and 720 occur concurrently following slots 713 and 719. During slots 714 and 720, secondary device 705 transmits the data 747 and secondary device 709 transmits the data 780. Slots 715 and 721 occur concurrently following slots 714 and 720. During slot 715, secondary device 706 switches from receive mode to transmit mode, as numeral 753 indicates (Rx2Tx). Similarly, during slot 721, secondary device 710 switches from receive mode to transmit mode, as numeral 786 indicates (Rx2Tx). Although a single slot 715 is depicted between slots 714 and 716 and a single slot 721 is depicted between slots 720 and 722, any number of slots may be included between slots 714 and 716, and the same number of slots may be included between slots 720 and 722.

Slots 716 and 722 occur concurrently following slots 715 and 721. During slot 716, secondary device 706 transmits data 755 to primary device 703 (while in receive mode 754, TsMaxTx). In some examples, the secondary device 706 already transmitted data 755 to primary device 703 during a prior slot between slots 714 and 716. Thus, by transmitting data 755 twice during different time slots, the risk of data loss is mitigated. Similarly, during slot 722, secondary device 710 transmits data 788 to primary device 707 (while in transmit mode 787, TsMaxTx). In some examples, secondary device 710 will have already transmitted data 788 to primary device 707 during a prior slot between slots 720 and 722. Thus, by transmitting data 788 twice during different time slots, the risk of data loss is mitigated.

Redundant data transmissions need not occur in consecutive slots. Transmission of the same data in non-consecutive time slots can be beneficial, for example, if the passage of additional time between the slots facilitates the removal of a condition or physical obstacle that was preventing successful reception of the data in the first of the two time slots. The data transmission redundancy described above may be achieved if the datum is transmitted twice to the same primary device. For example, a particular datum may be transmitted to a first primary device, on a first frequency, and in a first superframe, and then again to the same first primary device, on a second frequency different than the first frequency, and in a second superframe concurrent with the first superframe. Data redundancy also may be achieved even if the datum is transmitted twice on the same frequency. For example, a particular datum may be transmitted to a first primary device, on a first frequency, and in a first superframe, and then again to a second primary device, on the same first frequency, and in a second superframe that is concurrent with the first superframe. Data redundancy also may be achieved even if the datum is transmitted twice on the same frequency and to the same primary device. For example, a particular datum may be transmitted to a first primary device, on a first frequency, and in a first superframe, and then again to the same first primary device, on the same first frequency, but in a second superframe concurrent with the first superframe. In other examples, a particular datum is transmitted twice in a given superframe interval, to differing primary devices, and on different frequencies. Any and all such variations are contemplated and included in the scope of this description.

To mitigate the risk of interference between simultaneous data transmissions, and further to mitigate the risk that same-data transmissions during separate slots fail to reach their destinations, secondary devices may use any of a variety of frequency hopping schemes. For example, with reference to timing diagram 700, in concurrent slots 713 and 719, the data 743 may be transmitted on a first frequency, and the data 776 may be simultaneously transmitted on a second frequency that is different than the first frequency. The first and second frequencies may be separated by at least 5 MHz or by at least 10 MHz (or, in terms of channels, the channels used are at least two channels, three channels, or five channels apart). Similarly, in concurrent slots 714 and 720, the data 743 and 776 may be simultaneously transmitted on first and second frequencies, respectively, with the first and second frequencies separated by at least 5 MHz or by at least 10 MHz (or, in terms of channels, the channels used are at least two channels, three channels, or five channels apart). Using different frequencies for simultaneous data transmission mitigates the risk of interference between the transmissions. Separation of at least 5 MHz or 10 MHz are examples of minimum separations; in some examples, the techniques of this description may be implemented with minimum frequency separation other than 5 MHz or 10 MHz. Techniques to ensure multiple primary devices 104 maintain at least a predetermined minimum frequency separation are described further in connection with FIG. 13.

Different frequencies also may be useful across different slots. For example, in timing diagram 700, a first frequency may be employed for transmissions in slot 713 and a second frequency may be employed for transmission in slot 720, where the first and second frequency are separated from one another by at least 5 MHz or by at least 10 MHz (or, in terms of channels, the channels used are at least two channels, three channels, or five channels apart). To facilitate such separation in transmission frequencies, primary devices (e.g., primary devices 104) may transmit in their downlinks to secondary devices (e.g., secondary devices 106) specific frequency hopping schemes that are to be used during data transmissions. Furthermore, in some examples, secondary devices may receive and transmit data on similar frequencies. For example, with reference to timing diagram 700, the secondary device 704 may receive data 724 in slot 711 on a first frequency, receive data 727 in slot 712 on a second frequency, and transmit data 743 in slot 713 on a third frequency. In some examples, the first and third frequencies may be the same.

As just one example, a primary device can use a frequency hopping sequence with thirty-seven channels in the industrial, scientific, and medical (ISM) band. These bands have a random order in the hopping sequence and satisfy the condition that the adjacent frequencies are separated by 5 MHz or by 10 MHz. For example, the first hopping sequence is {2410 MHz, 2404 MHz, 2416 MHz, . . . }. The second hopping sequence can be a different version of the first hopping sequence, except shifted by one position. Hence, the second hopping sequence is {2404 MHz, 2416 MHz, . . . 2410 MHz}, preserving at least a 5 MHz separation or at least a 10 MHz separation for the primary device operating in a first frequency (2410 MHz) and another primary device operating in a second frequency (2404 MHz). After each hop, the first and second frequencies remain 5 MHz apart or 10 MHz apart.

In addition to transmitting frequency hopping schemes in downlinks, the primary devices 104 may transmit scheduling instructions to the secondary devices 106 in downlinks. For example, one or more primary devices 104 may be configured to instruct secondary devices 106 regarding the specific slots of a given superframe(s) and the specific channels or frequencies in which the secondary devices 106 are to transmit uplinks to the primary devices 104. The primary devices 104 may change the scheduling instructions with each superframe interval, or, alternatively, may maintain the same scheduling instructions for multiple consecutive superframe intervals. The primary devices 104 may also transmit additional information to the secondary devices 106, such as acknowledgements for uplink transmissions from a previous superframe, an indication when the next superframe may begin, an adaptive frequency hopping countdown, etc. In some examples, the primary devices 104 do not transmit scheduling instructions to the secondary devices 106 in the downlinks. Instead, some or all devices in the WBMS 100 are preprogrammed with a defined schedule that is to be followed for some or all superframe intervals, unless instructed otherwise by one or more primary devices 104. Alternatively, primary devices 104 may transmit a single downlink with scheduling instructions that are to be followed in all superframe intervals until further notice. The battery controller device 102 may provide the primary devices 104 with scheduling instructions that the primary devices 104 may then disseminate to the remaining devices of the WBMS 100.

The secondary devices 106 transmit data to the primary devices according to the scheduling instructions and channel or frequency instructions provided by the primary devices 104 or preprogrammed into the secondary devices. After receiving a downlink transmission from a primary device 104-1, a secondary device 106-2 may parse the transmission to determine the slots and channels or frequencies in which the secondary device 106-2 is scheduled to uplink information to the primary device(s). In some examples, information for how to parse the downlink transmission may be provided to the secondary device during a WBMS network formation process.

In some examples, secondary devices include multiple transceivers. For example, as shown in FIG. 2, the secondary device 106-1 includes multiple transceivers 128-1. Accordingly, the secondary device 106-1 may simultaneously (in the same slot) transmit data 743 twice using different transceivers 128-1. Such simultaneous transmissions may occur at the same or different frequencies. The transmissions may be directed to the same or different primary devices 104 (e.g., both the secondary and primary devices may have multiple transceivers communicating simultaneously on different frequencies). Thus, the same level of redundancy that is achieved by single-transceiver secondary devices transmitting the same data in different slots can be achieved by multi-transceiver secondary devices in a more compressed timeframe.

In some examples, the primary devices 104-1 and 104-2 may be spatially positioned apart from each other (e.g., 6.25 cm (half the wavelength at 2.4 GHz) apart) within the WBMS 100. Providing a threshold amount of distance between the primary devices increases the likelihood that environmental obstacles hindering the successful transmission of data packets to one primary device will not likewise hinder the successful transmission of data packets to the other primary device.

In some examples, uplink data transmissions may be performed in consecutive slots of concurrent superframes to accommodate large amounts of data that could not otherwise be transmitted in a single uplink. Such techniques are described in commonly assigned U.S. Application Publication No. 2025/0039859, entitled “Methods and Apparatus to Determine Communication Schedules for Wireless Battery Systems,” filed Jul. 28, 2023, which is hereby incorporated herein by reference in its entirety.

FIG. 8 is an illustrative example of timing synchronization between a primary device and secondary device in the example implementation of the WBMS of FIG. 6. The example of FIG. 8 includes the primary device 104-1 and the secondary device 106-2 from the example WBMS 100 implementation of FIG. 6. FIG. 8 also includes example Down Links (DL) frames 802-1, 802-2, and 802-3 (collectively referred to as DL frames 802). A given DL 802-1 includes a corresponding PHY frame 804-1. The example PHY frame 804-1 includes an example preamble 806, an example Synchronization Header (SHR) 808, an example PHY header (PHR) 810, and an example payload 812. The example of FIG. 8 also includes a timeline that includes times T1, T2, T3, and T4. Distances on the timeline of FIG. 8 may be disproportionate to the passage of time. For example, the amount of time between T0 (the start of the DL 802-1) and T3 (the start of the DL 802-2) is equal to the amount of time between T3 and T4 (the start of the DL 802-3), despite the distance between T0 and T3 being unequal to the distance between T3 and T4. The timeline of FIG. 8 is independent of any timeline described in connection with the foregoing figures. While the example of FIG. 8 is described with reference to the secondary device 106-1, the techniques described below may be implemented by any of the secondary devices 106.

EIS battery health monitoring operations require synchronous measurements of the battery cells 108 as described above in connection with FIG. 6. However, the internal clock signals within independent devices can drift apart over time due to minute differences in the clock generation circuits. Accordingly, in examples described herein, one or more controller devices and monitor circuits within the WBMS 100 adjust their internal clock signals to the same reference clock signal before performance of the measurement operations. Adjusting internal clock signals enables multiple devices to agree that a given timestamp refers to the same point in time with a high degree of precision, thereby enabling synchronous battery health measurements. As used above and herein, the terms “controller device” and “controller devices” may refer to one or more of the battery controller devices 102, the primary devices 104, or the secondary devices 106 in the WBMS 100.

In the examples of FIGS. 8-9B, the internal clock signal of the primary device 104-1 is used as the reference clock for the WBMS 100. Accordingly, FIG. 8 describe how a given secondary device 106-2 adjusts its internal clock based on the primary device 104-1, and FIGS. 9A and 9B describe how the battery controller device 102-1 adjust its internal clock based on the primary device 104-1. In other examples, a different device for the WBMS 100 is selected to provide the reference clock signal for synchronization. In such examples, the remaining devices in the WBMS 100 adjust their clock signals based on the selected device. The selected device may include but is not limited to the battery controller device 102-1, the primary device 104-2, one of the secondary devices 106.

In the example of FIG. 8, the secondary device 106-2 adjusts its internal clock signal based on the PHY frames 804 sent by the primary device 104-1 during the DL frames 802 of each superframe interval. In particular, the end of the preamble 806 and the start of the SHR 808 can serve as a synchronization point during each of the DL frames 802. The primary device 104-1 describes when the synchronization point of a given DL frame 802-1 occurred by including a reference time within the payload 812 of the DL frame 802-1. The reference time of a given DL frame 802-1 refers to a timestamp that accurately represents the internal clock signal of the primary device 104-1, within the margin of error acceptance limit of the WBMS 100, at the time the primary device 104-1 transmitted the SHR 808 corresponding to the DL frame 802-1. Thus, the payload 812 of PHY frame 804-1 includes a timestamp that describes the internal clock signal of the primary device 104-1 at T1, and the payload of PHY frame 804-2 includes a timestamp that describes when the primary device 104-1 began transmission of SHR 808 within the PHY frame 804-2 (e.g., an amount of time after T3). Timestamps as described above and herein may be formatted in any suitable format, including but not limited to seconds since the epoch. In some examples, a reference time within a PHY payload is referred to as SHR time.

The PHY frames 804 are standardized data structures that have predetermined lengths. The secondary device 106-2 is therefore preprogrammed with a value (e.g., x in FIG. 8) that describes the amount of time between the end of a PHY frame 804-1 (e.g., T2 in FIG. 8) and the synchronization point (e.g., T1 in FIG. 8). When PHY frame 804-1 ends, the secondary device 106-2 subtracts ΔT from a timestamp that describes the current time (T2). The resulting value of (T2−ΔT) is a timestamp that describes T1 according to the internal clock of the secondary device 106-2. The secondary device 106-2 then compares the calculated T1 timestamp to the reference time (e.g., the T1 timestamp within the payload 812). The two timestamps are preferably equal because such a comparison indicates the secondary device 106-2 is synchronized to the primary device 104-1. If the timestamps are unequal, the difference between the timestamps quantify the extent to which the clock signals of the primary device 104-1 and secondary device 106-2 are offset from one another. The secondary device 106-2 can use the reference time to match its internal clock signal to the primary device 104-1 by adjusting the internal clock of the secondary device 106-2 based on the difference between timestamps. The secondary device 106-2 may adjust its internal clock using any suitable techniques, including but not limited to providing the difference between timestamps as an error signal to Phase Locked Loop (PLL) circuitry. In some examples, the foregoing clock signal adjustments may be referred to as the secondary device 106-2 matching its internal clock to the primary device 104-1 by using the reference time. The secondary device 106-2 accounts for transmission latencies over the wireless interface when comparing timestamps in FIG. 8 so that the latencies are not considered when quantifying the offset between clock signals.

Advantageously, the secondary device 106-2 does not need to synchronize its clock signal to the primary device 104-1 during each of the DL frames 802. In general, the secondary device 106-2 can wait for a reasonable period between performances of the foregoing clock synchronization operations. The length of the reasonable period may depend on any number of factors including but not limited to the accuracy needed (for the EIS battery measurements or for other use cases), the expected clock drift of the secondary device 106-2 and the primary device 104-1, etc. Thus, a given DL frame 802-2 represents an opportunity (but not a requirement) for the secondary device 106-2 to correct for any clock drift that may have occurred since the last time the secondary device 106-2 synchronized its clock to the primary device 104-1. This distinction between opportunity and requirement adds robustness to the WBMS 100 as the volatility of wireless transmissions may cause packet loss that prevents the secondary device 106-2 from receiving some of the DL frames 802.

FIGS. 9A and 9B are illustrative examples of timing synchronization between the battery controller and a primary device in the example implementation of the WBMS of FIG. 6. In the examples of FIGS. 9A and 9B, the battery controller device 102-1 adjusts its internal clock to match the clock signal of the primary device 104-1 as described above. In other examples, the primary device 104-1 adjusts its internal clock signal to match the battery controller device 102-1. The timelines of FIGS. 9A and 9B are independent of one another and of any timeline described in connection with the foregoing figures.

In both of FIGS. 9A and 9B, the battery controller device 102-1 adjusts its internal clock based on a difference between timestamps as described in FIG. 8, where one timestamp is generated by the device containing the reference clock (the primary device 104-1) and one timestamp is generated by the device to be adjusted (the battery controller device 102-1). In the example of FIG. 9A, the primary device 104-1 may be configurable to provide its timestamp to the battery controller device 102-1 in response to a query time reference message from the battery controller device 102-1. Additionally or alternatively, the primary device 104-1 may be configurable to periodically send its time reference to the battery controller device 102-1 and the secondary devices 106 without the battery controller device 102-1 sending a query for the time reference. Just as the start of the SHR 808 served as a reference point in FIG. 8, the timestamp generated by the primary device 104-1 in FIG. 9A sits within a payload of a frame and refers to a known timing point such as the start of a Frame Header or specific field in the frame header. In FIG. 9A, the known timing point is the start of a ‘Time Sync Field’ that precedes the response payload that contains the timestamp.

The battery controller device 102-1 and primary device 104-1 may use any suitable communication protocol to exchange the query time reference and response. Such protocols include but are not limited to Serial Peripheral Interface (SPI) and Universal Asynchronous Receiver Transmitter (UART), Controller Area Network (CAN), Application Programming Interfaces (APIs), etc. In some examples and as noted above, the primary device 104-1 periodically transmits FIG. 9A packet instead of the battery controller device 102-1 transmitting a time reference query.

In the example of FIG. 9B, the primary device 104-1 generates a timestamp whose known timing point is a General Purpose Input Output (GPIO) interrupt sent from the primary device 104-1 to the battery controller device 102-1. The primary device 104-1 may transmit the GPIO interrupt to the battery controller device 102-1 for any reason (e.g., an event such as a battery measurement or an error occurred, one of the secondary devices 106 or the primary device 104-1 have changed state, etc.). In the example of FIG. 9B, the primary device 104-1 may transmit the timestamp as a serial data payload that is separate from the GPIO interrupt. The battery controller device 102-1 accounts for transmission delays over a wired interface when comparing timestamps in FIGS. 9A and 9B so that the latencies are not considered when quantifying the offset between clock signals.

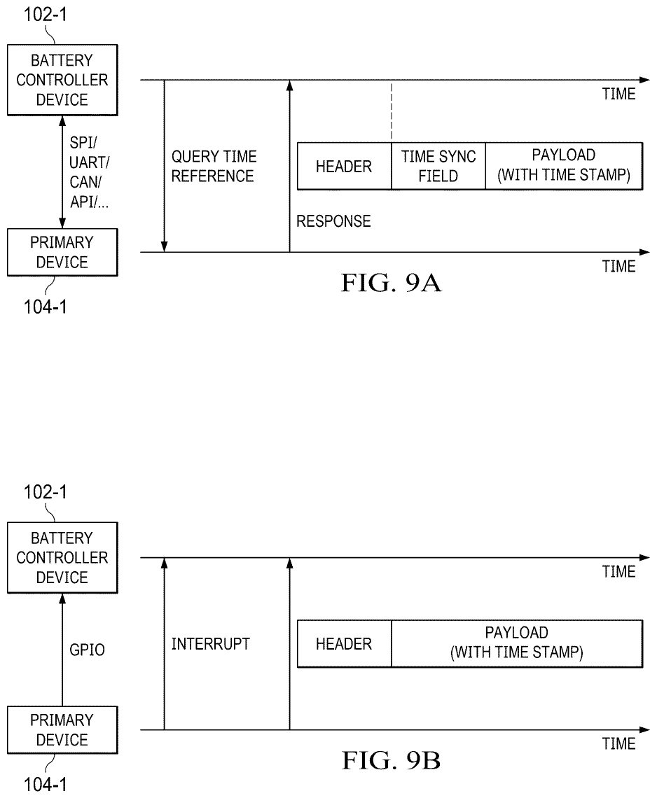

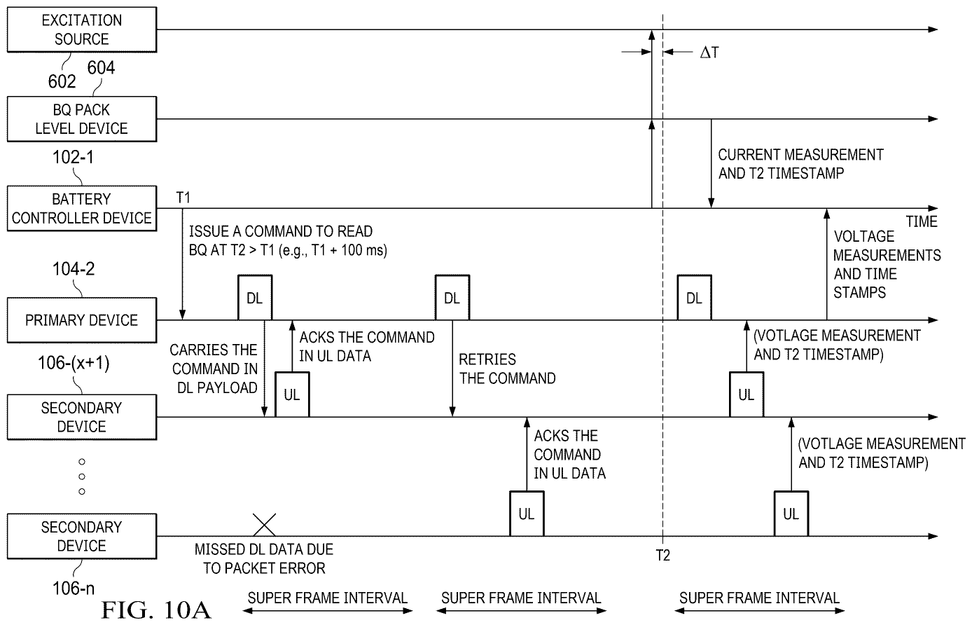

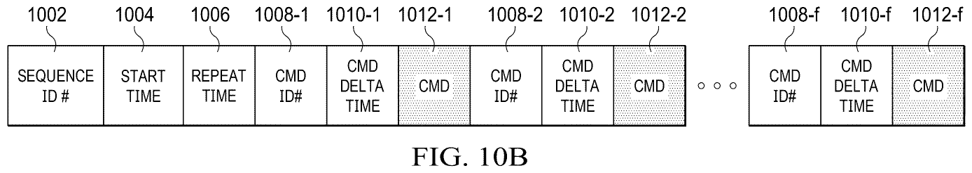

FIG. 10A is an illustrative example of a schedule protocol that may be implemented within the WBMS of FIG. 6. FIG. 10A includes the excitation source 602, the BQ pack-level device 604, the battery controller device 102-1, the primary device 104-2, and the secondary devices 106-(x+1) through 106-n as described in FIG. 6. The example of FIG. 10A also includes a timeline that includes T1 and T2. The timeline of FIG. 10A is independent of any timeline described in connection with the foregoing figures.

After the controller devices (e.g., the battery controller device 102-1, the primary devices 104, and the secondary devices 106) of the WBMS 100 synchronize to a common reference clock signal using the techniques described above, the battery controller device 102-1 can implement the schedule protocol shown in FIG. 10A. As used above and herein, the term “schedule protocol” refers to a technique in which a destination device receives a message that instructs the device to perform operations at a scheduled time in the future. For example, at T1 in FIG. 10A, the battery controller device 102-1 provides a message the primary device 104-2 that commands the BQ circuits 502 to synchronously perform battery measurements at T2. Accordingly, the primary device 104-2 in the DL of the next superframe interval that follows T1. As used above and herein, a destination device refers to a device within the WBMS 100 that performs operations synchronously with other destination devices. For example, in FIG. 6 the excitation source 602, the BQ pack-level device 604, and the BQ circuits 502 are all destination devices.

While the DL containing the measurement is transmitted to each of the secondary devices 106-(x+1) through 106-n that correspond to the primary device 104-2, packet error caused by transmission over a wireless medium may prevent some recipient devices from receiving the command. For example, while the secondary device 106-(x+1) receives the command in the first superframe interval of FIG. 10A and acknowledges the command during its subsequent UL frame, the secondary device 106-n misses the DL data from the first superframe interval due to packet error. Accordingly, there is a failure from the secondary device 106-(x+1) to acknowledge the instruction after the first transmission.

Advantageously, the battery controller device 102-1 implements the schedule protocol by selecting a scheduled measurement time (T2) far enough in the future to allow time for multiple retransmissions across the wireless medium. For example, in FIG. 10A there are two superframe intervals between T1 (the issuance of the command) and T2 (the scheduled measurement time described in the command). The second superframe interval enables the primary device 104-2 to retry transmission of the command after the first failed transmission and before the command becomes stale (e.g., before T2). FIG. 10A shows the secondary device 106-n successfully receives the command from the DL frame of the second superframe interval and acknowledges the command in its subsequent UL frame. In some examples, the retransmitted message in the second superframe interval of FIG. 10A is identical to the original message within the first superframe interval. In other examples, the retransmitted message in the second superframe interval of FIG. 10A is not identical to the original message within the first superframe interval, but the retransmitted message still instructs the destination device to perform a measurement at T2.

In this example, the difference between T1 and T2 is approximately 100 milliseconds (ms). Thus, the battery controller device 102-1 scheduled a measurement at least 100 ms in the future while determining when to perform a measurement in the example FIG. 10A. More generally, the battery controller 102-1 may schedule battery measurements any amount of time in the future. A manufacturer or designer of the WBMS 100 may determine how the battery controller device 102-1 schedules measurements by balancing measurement rates (e.g., the number of measurements per unit of time decreases as the amount of time between a command and subsequent measurements increases) against system robustness (e.g., the likelihood of a given secondary device successfully receiving the command increases proportionally with the amount of time between a command and subsequent measurements due to the extra opportunities for retransmissions). In some examples, the battery controller device 102-1 is configurable to estimate a number of retransmissions before the first monitor circuit successfully receives the first message and select the scheduled time based on the estimated number of retransmissions. The estimation of such examples may be performed using any suitable techniques, including but not limited to empirical analysis.

EIS operations preferably include both synchronous voltage measurements from the BQ circuits 502 and synchronous current measurements from the BQ pack-level device 604. Accordingly, the battery controller device 102-1 transmits a message to the BQ pack-level device 604. In the example of FIG. 10A, the message causes the BQ pack-level device 604 to perform a measurement upon receipt. As used above and herein, a measurement that occurs “upon receipt” of a message does not refer to a measurement that occurs at a specific time (as the command at T1 includes), but rather to a measurement that occurs as soon as the recipient device processes the message. Such processing operations include but are not limited to demodulating the message from a carrier wave, filtering the message, decoding the message, interpreting the message, sending a command to sensor hardware on the recipient device, etc. In some examples, devices that communicate over a wireless medium perform demodulation operations while devices that communicate over a wired medium do not perform demodulation, which allows for a wired device to initiate a battery measurement more quickly than a wireless device.

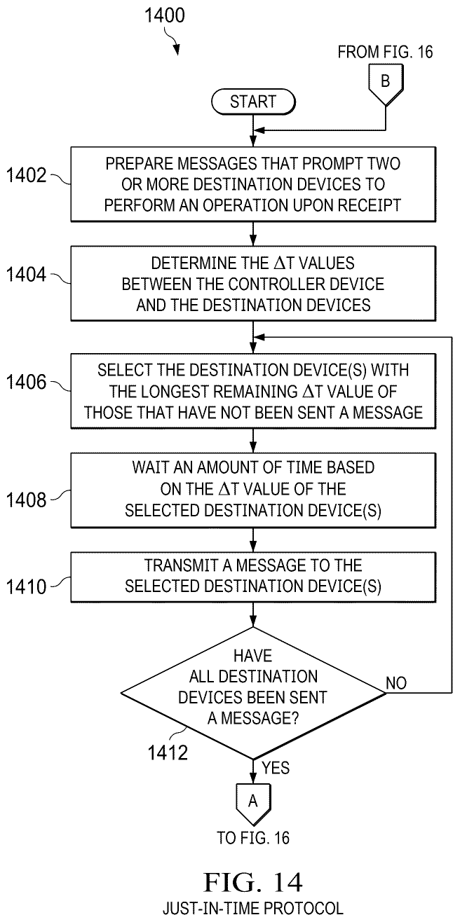

A designer or manufacturer of the WBMS 100 may choose whether to send a message that causes measurement upon receipt or measurement at a scheduled time based on the type of transmission medium. In the example WBMS 100 shown in FIG. 6, the likelihood of packet loss between the battery controller device 102-1 and the BQ pack-level device 604 is negligible because the two devices are directly coupled to one another over a wired medium. Thus, in the example of FIG. 10A, the battery controller device 102-1 transmits a message that causes measurement upon receipt to the BQ pack-level device 604 because the BQ pack-level device 604 is statistically likely to receive the message after only one transmission. In contrast, the likelihood of packet loss the primary device 104-2 and the secondary devices 106-(x+1) through 106-n is comparatively large due to the wireless transmission medium. Therefore, in the example of FIG. 10A, the battery controller device 102-1 transmits a message that causes measurement at a scheduled time to the secondary devices 106-(x+1) through 106-n to allow time for retransmissions before the measurement. Messages that cause measurement upon receipt and messages that cause measurement at a scheduled time are described further in connection with FIGS. 14 and 15.

In general, devices that transmit a message which causes measurement upon receipt determine when to transmit said message based on a time delta (labeled ΔT in FIG. 10A) between a) the transmission of the message and b) the recipient device starting operations. For example, in the example of FIG. 10A, the ΔT between battery controller device 102-1 and the BQ pack-level device 604 is approximately equal to the sum of a) the communication latency between the battery controller device 102-1 and the BQ pack-level device 604 and b) the time required for the BQ pack-level device 604 to process the message as described above. Thus, the battery controller device 102-1 waits until (T2−ΔT) to transmit the message to the BQ pack-level device 604.

The monitor circuits perform measurement operations to quantify how the battery cells 108 respond to an AC signal as described above. Accordingly, the battery controller device 102-1 also transmits a message to excitation source 602 to cause the excitation source 602 to generate the AC signal at T2 (or an amount of time before T2) so that the battery cells 108 begin to respond to the AC signal, and corresponding EIS measurements begin, at T2. The ΔT between battery controller device 102-1 and the excitation source 602 is based on the amount of time required for the excitation source 602 to physically provide a stable frequency and settle down. In the example of FIG. 10A, the ΔT between battery controller device 102-1 and the excitation source 604 is equal to the ΔT between battery controller device 102-1 and the BQ pack-level device 604. Accordingly, FIG. 10A shows the battery controller device 102-1 transmits messages to the excitation source 602 and the BQ pack-level device 604 at the same time. In other examples, the ΔT values between a transmitter device and two receiver devices are different. In some examples, the battery controller device 102-1 transmits messages that cause one or both of the excitation source 602 and BQ pack-level device 604 to perform operations at a scheduled time (as opposed to transmitting messages that cause the devices to perform operations upon receipt of the message as shown in FIG. 10A).

The messages sent by the battery controller device 102-1 cause at least the secondary device 106-(x+1), the secondary device 106-n, and the BQ pack-level device 604 to synchronously perform battery measurements at T2. This can mean that the secondary device 106-n and the BQ pack-level device 604 do not necessarily receive the messages at the same time but perform battery measurements at substantially the same time after decoding the messages. The monitoring circuits then asynchronously return their measurement data to the battery controller device 102-1. Examples of asynchronous communications include communications that are not concurrent, communications that are not at the same time, communications with little or no overlap in time, etc. For example, the secondary devices 106-(x+1) and 106-n wait to wirelessly transmit their voltage measurement data back to the primary device 104-2 until their respective UL frames within the superframe interval that follows T2. In this example the primary device 104-2 sends one message to the battery controller device 102-1 per superframe interval that includes all voltage measurement data received during the superframe interval. In other examples, the primary device 104-2 forwards voltage measurement data as soon as it is received from one of the BQ circuits 502 or at a different frequency. In contrast to the secondary devices 106, the BQ pack-level device 604 does not participate in the superframe intervals that coordinate wireless communications. Thus, the BQ pack-level device 604 can return its current measurement data to the battery controller device 102-1 at any time after a) the measurement occurs and b) the measurement data is formatted, packaged, etc. for transmission. In the example of FIG. 10A, the BQ pack-level device 604 returns its current measurement data before the secondary devices 106-(x+1) and 106-n.

The asynchronous return of measurement data to the battery controller device 102-1 removes the ability for the battery controller device 102-1 to receive timing information based on the order in which measurement data is received. Instead, the WBMS 100 implements the schedule protocol by preprogramming one or more of the monitor circuits to include timestamps that describe when a measurement occurred within messages that include the corresponding measurement data. Thus, in the example of FIG. 10A, each of the secondary device 106-(x+1), the secondary device 106-n, and the BQ pack-level device 604 include a timestamp that describes T2 inside the messages that contain their respective measurement data. By doing so, the battery controller device 102-1 can receive measurement data in any order and still perform accurate EIS operations by grouping the measurement data by their timestamps. In some examples, the BQ pack-level device 604 does not include timestamps with its measurement data because the battery controller device 102-1 can presume the BQ pack-level device 604 immediately returns its measurement data once it is prepared for transmission as described above.

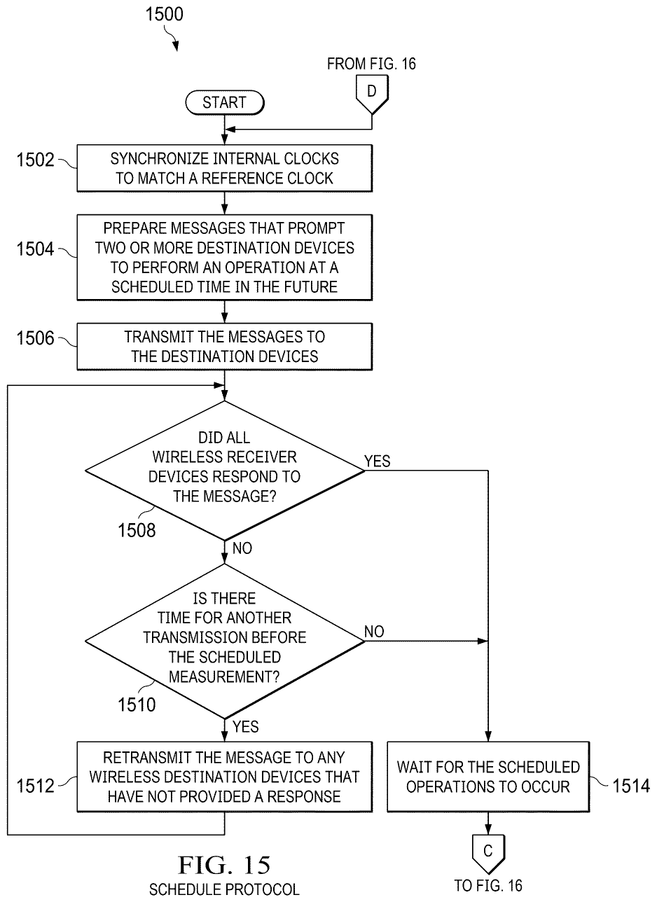

While the example of FIG. 10A shows the secondary devices 106-(x+1) and 106-n successfully received the command issued at T1, packet loss may have prevented one or more of the secondary devices 106-(x+2), 106-(x+3), . . . , 106-(n−1) from receiving the command before the scheduled time of T2. More generally, there is no way to guarantee that all secondary devices 106 successfully received a message before the scheduled measurement time described within the message. Accordingly, in some examples, the battery controller device 102-1 may receive battery measurements from only a subset of monitor circuits that were instructed to perform a measurement. Techniques to respond to packet loss are described further in FIG. 16.

In the example of FIG. 10A, the messages issued by the battery controller device 102-1 cause the monitor circuits to perform one measurement at T2. In other examples, the battery controller device 102-1 issues messages that cause the monitor circuits to perform measurements periodically, where the first measurement starts either upon receipt of the message or at a scheduled time described within the message. For example, the message may cause a monitor circuit to perform a first measurement at a specific time and then repeat the measurement every 100 ms. In such examples, successful receipt of a message enables a given monitor circuit to perform multiple measurements (as opposed to one measurement per successful receipt of a message shown in FIG. 10A). The battery controller device 102-1 can also overlap instructions with scheduled measurements so that a given superframe interval includes a) a DL frame that includes an original transmission or retransmission of a message that causes a measurement at a scheduled time in the future and b) UL frames that return data from measurements that occurred in the past.

FIG. 10B is an illustrative example of a sequence definition that may instruct devices within the WBMS 100 to perform measurements periodically as described above. FIG. 10B includes a sequence definition that includes an example sequence identifier (ID) 1002, an example start time 1004, an example repeat time 1006, example command (CMD) IDs 1008-1, 1008-2, . . . , 1008-f (collectively referred to as CMD IDs 1008), CMD delta times 1010-1, 1010-2, . . . , 1010-f (collectively referred to as CMD delta times 1010), and commands 1012-1, 1012-2, . . . , 1012-f (collectively referred to as commands 1012).

As used above and herein, a sequence refers to one or more commands that a destination device performs repeatedly. A sequence can have any number of commands (represented by the natural number f in the example of FIG. 10B). In some examples, a controller device uses the sequence definition of FIG. 10B to instruct a monitor circuit to perform a sequence of measurements.

The example sequence definition of FIG. 10B includes one sequence ID 1002, one start time 1004, and one repeat time 1006 per sequence. The sequence ID 1002 is a value that uniquely identifies a given sequence. The start time 1004 describes the time at which the destination devices should begin to perform the sequence. The start time 1004 is described relative to the reference clock signal that synchronizes destination devices as described above. The repeat time 1006 describes the amount of time between the start of any two subsequent iterations of the sequence. Accordingly, the controller device ensures the repeat time 1006 is larger than the time required for a given destination device to perform the f commands that collectively compose one iteration of the sequence.

The example sequence definition of FIG. 10B includes one CMD ID (e.g., 1008-1) and one CMD delta time (e.g., 1010-1) per command (e.g., 1012-1) within the sequence. The CMD ID 1008-2 is a value that uniquely identifies a corresponding command 1012-2. The CMD delta time 1010-2 describes the amount of time the destination device waits in between execution of the previous command 1012-1 before and execution of the current command 1012-2. In some examples, a controller device varies the values of one or more CMD delta times 1010 from one another so that the destination devices wait different amounts of after executing different ones of the commands 1012. Finally, a command 1012-1 refers to instructions that cause the destination devices to perform one or more operations (e.g., perform a battery measurement, generate an AC signal, etc.) synchronously with one another. In some examples, the sequence definition of FIG. 10B is considered part of the schedule protocol because the start time 1004 refers to a point in time in the future and therefore requires synchronization amongst the destination devices as described above.

FIG. 10C is an example implementation of the sequence definition of FIG. 10B. The example of FIG. 10C includes the secondary device 106-2, the BQ circuit 502-2, and a timeline with timestamps in milliseconds. The timestamps are relative to the synchronized reference clock signal described above. In some examples (such as FIG. 10C), the synchronized reference clock signal is referred to as network time.

The secondary device 106-2 receives an entire sequence definition from the primary device 104-1 before beginning a sequence (at network time 1000 in FIG. 10C). In some examples, the secondary device 106-2 receives all portions of the message format in a single message from the primary device 104-1. In other examples, the secondary device 106-2 receives the sequence definition of FIG. 10B across multiple messages.

In the example of 10C, the commands in the sequence definition are executed by the secondary device 106-2. Such commands cause the secondary device to 106-2 to read or write data from certain memory registers on the BQ circuit 502-2, thereby triggering battery measurements or obtaining the measurement data. In other examples, the commands are forwarded from the secondary device 106-2 to the BQ circuit 502-2 and then executed by the BQ circuit 502-2.

In general, a device that executes commands does so at specific times as described by the sequence definition. In the example of FIG. 10C, the secondary device 106-2 returns results of the commands to the primary device 104-1 using a response message. A given response message includes the CMD ID value for the corresponding command, a measure timestamp that describes when the command was executed, and a payload (data that represents the response itself). The payload may include an acknowledgement the command was executed, data obtained as a result of the command execution, other types of information, etc. In the example of FIG. 10C, the secondary device 106-2 transmits the response message in the next available UL slot in a superframe interval. In other examples where a sequence includes commands that are executed directly by a BQ circuit 502-1, the BQ circuit 502-1 may transmit a response message to the primary device 104-1 independently of any superframe interval timing.

In this example, a device that executes a sequence executes a given command in the sequence definition only once per iteration. Moreover, retransmissions from the secondary device 106-2 to the primary device 104-1 will retransmit the same response.

In the example of FIGS. 10B and 10C, the BQ circuits 502 continue to repeat the sequence until a controller device provides a separate stop instruction (AKA a halt instruction or an abort instruction). In other examples, a controller device instructs the BQ circuits 502 to stop performing the sequence after a certain number of iterations and provides said instructions within the same message(s) that initialize the sequence. In still other examples, controller devices in the WBMS 100 uses a different technique besides the sequence definition of FIGS. 10B and 10C to instruct other devices to perform multiple operations synchronously with one another.

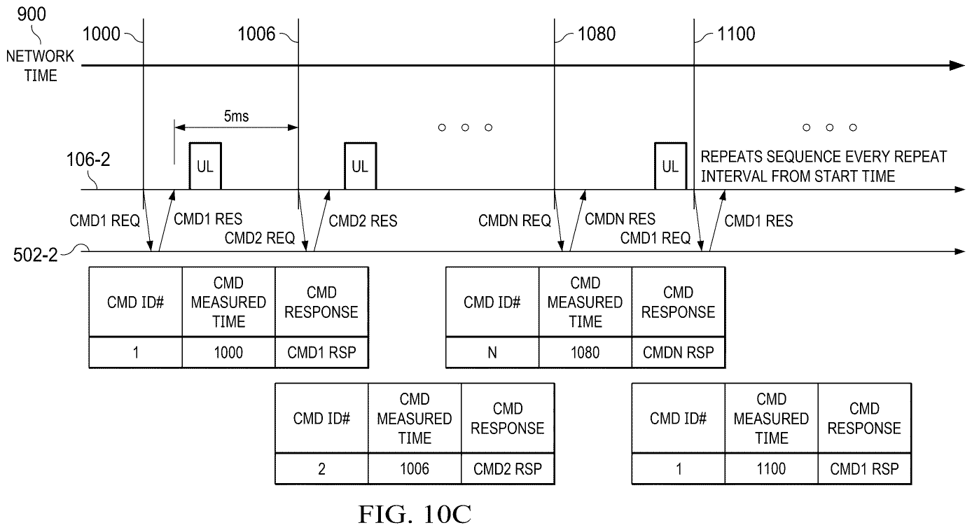

FIG. 11 is an illustrative example of a just-in-time protocol that may be implemented within the WBMS of FIG. 6. The example of FIG. 11 includes the primary device 104-1, the BQ circuit 502-1 (which is coupled to the primary device 104-1 over a wired medium), and the secondary devices 106-2 through 106-x of FIG. 6. FIG. 11 also includes a timeline with times TO, T1, and T2. The timeline of FIG. 11 is independent of any timeline described in connection with the foregoing figures. Like the timeline of FIG. 8, distances on the timeline of FIG. 11 may be disproportionate to the passage of time.

As used above and herein, the term “just-in-time” protocol refers to a technique in which a destination device receives a message that instructs the device to perform operations upon receipt as described above. For example, in FIG. 11, the primary device 104-1 sends messages that cause both the BQ circuit 502-1 (which is coupled over a direct wired mediums) and the BQ circuits 502-2 through 502-x (which are coupled over intermediate wireless mediums) to perform voltage measurements upon receipt. The voltage measurements are preferably synchronized in time with one another to support EIS operations as described above. Thus, the primary device 104-1 transmits messages so that each of the BQ circuits 502-1 through 502-x preferably receive their respective messages at T1, process the messages in approximately the same amount of time, and perform the measurements together at T2 after the processing operations. After the synchronous measurement operations of T2, the BQ circuits 502-1 through 502-x asynchronously return their measurement data as described above.

As described above in FIG. 10A, a ΔT value refers to a time delta between a) the transmission of a message and b) the recipient device being ready to perform operations based on the message. In the example of FIG. 11, the ΔT values between the primary device 104-1 and the BQ circuits 502-1 through 502-x are different because BQ circuit 502-1 is not coupled over a wireless medium. Accordingly, the primary device 104-1 first transmits messages (labeled TX₁₀₆ in FIG. 10A) at T0 to only the BQ circuits 502-2 through 502-x (via the secondary devices 106-2 through 106-x). The primary device 104-1 then waits for an adjustment period (labeled T_{ADJ} in FIG. 10A) and to send a message (labeled TX₅₀₂₋₁ in FIG. 10A) to the BQ circuit 502-1 at [T0+T_{ADJ}]. The primary device 104-1 may be configurable to delay the message TX₅₀₂₋₁ by T_{ADJ} so that devices 106 and 502 perform measurements at substantially the same time. The communication latency over the wireless medium between the primary device 104-1 and the secondary devices 106-2 through 106-x is comparatively high. Accordingly, the BQ circuits 502-2 through 502-x that successfully receive TX₁₀₆ do so at T1. The communication latency over the wired medium between the primary device 104-1 and the BQ circuit 502-1 is comparatively low. The BQ circuit 502-1 therefore also receives TX₅₀₂₋₁ at T1, enabling synchronous voltage measurements at T2 as described above. More generally, primary devices 104 can synchronize messages that cause measurement upon receipt by waiting for an adjustment period (T_{ADJ}) between message transmissions to compensate for different ΔT values.

The value of T_{ADJ} may change based on which devices within the WBMS 100 are implementing the just-in-time protocol. T_{ADJ} and ΔT values may depend on any number of factors, including but not limited to the size of the BQ command packets, the processing times of the one or more devices within the signal chain, etc. In general, T_{ADJ} are based on empirical analysis that test the signal chains between a source device (e.g., the primary device 104-1 in FIG. 11) and a destination device (e.g., the BQ circuits 502-1 through 502-x in FIG. 11) to estimate the various ΔT values between the source and destinations. In some examples, T_{ADJ} is a constant for a range of data packet sizes. In other examples, T_{ADJ} is adjusted based on each transmitted BQ command. The battery controller device 102-1 and/or the primary device 104-1 may be configurable to determine/modify the values of T_{ADJ} and ΔT using the techniques described herein. Additionally or alternatively, a designer or user may set the values of T_{ADJ} and ΔT using the techniques described herein.

In the example of FIG. 11, the synchronous battery measurements occur during a superframe interval and within a DL frame. Accordingly, the asynchronous return of battery measurement data can occur within the same superframe interval as the measurement in some more examples. Notably, the timing of synchronous battery measurements performed by the WBMS 100 occur independently of superframe intervals (even in examples where the asynchronous return of battery measurement data is dependent on a superframe).

Like the schedule protocol of FIG. 10A, controller devices that implement the just-in-time protocol shown in FIG. 11 cannot guarantee that each destination device will successfully receive the message to perform a measurement upon receipt. Thus, controller devices may use techniques to respond to packet loss (as described further in FIG. 16) regardless of whether the schedule protocol or the just-in-time protocol is implemented. Moreover, in some examples, controller devices that implement the just-in-time protocol are likely to have a fewer proportion of destination devices successfully receive the message than controller devices that implement the schedule protocol because the just-in-time protocol does not support the retransmission of measurement instructions prior to the measurement. However, in some examples, the just-in-time protocol supports a larger bandwidth (e.g., more measurements per unit of time) than the schedule protocol because the just-in-time protocol has less time between the issuance of a command and the corresponding measurement. Accordingly, a designer or manufacturer of the WBMS 100 may decide whether to implement the just-in-time protocol or the schedule protocol for a particular message by balancing the computational resources available, the likelihood of packet loss, and the safety or performance requirements of the WBMS 100.

In the examples of FIGS. 10 and 11, the battery controller device 102-1 uses a) the just-in-time protocol for the excitation source 602, the BQ pack-level device 604, and the BQ circuit 502-1 through 502-x and b) the schedule protocol for the BQ circuits 502-(x+1) through 502-n. More generally, any destination device can receive instructions for synchronous measurements using either the just-in-time protocol or the schedule protocol.

In the examples of FIGS. 10 and 11, the battery controller device 102-1 implements the just-in-time protocol and the schedule protocol by determining both a) when to send messages to the destination devices and b) what each message caused the corresponding destination device to do. In other examples, one or more of the primary devices 104 alternatively decide what command to send in a message and when to send the message. In such examples, the battery controller device 102-1 determines when measurement will occur synchronously but lets the primary devices 104 decide whether to effectuate such synchronous measurements using the just-in-time protocol or the schedule protocol. The primary devices 104-1 and 104-2 may use different protocols (as shown in FIGS. 10A and 11), or may use the same protocol, so long as all measurements occur synchronously based on the timing instructions set by the battery controller device 102-1. A designer or manufacturer of the WBMS 100 may choose which controller device(s) decide whether to implement the just-in-time protocol or the schedule protocol, or whether a given destination device receives messages using the just-in-time protocol or the schedule protocol, using any number of factors. Such factors include but are not limited to WBMS data requirements, WBMS error requirements, the types of hardware components used to implement the various WBMS devices, etc.

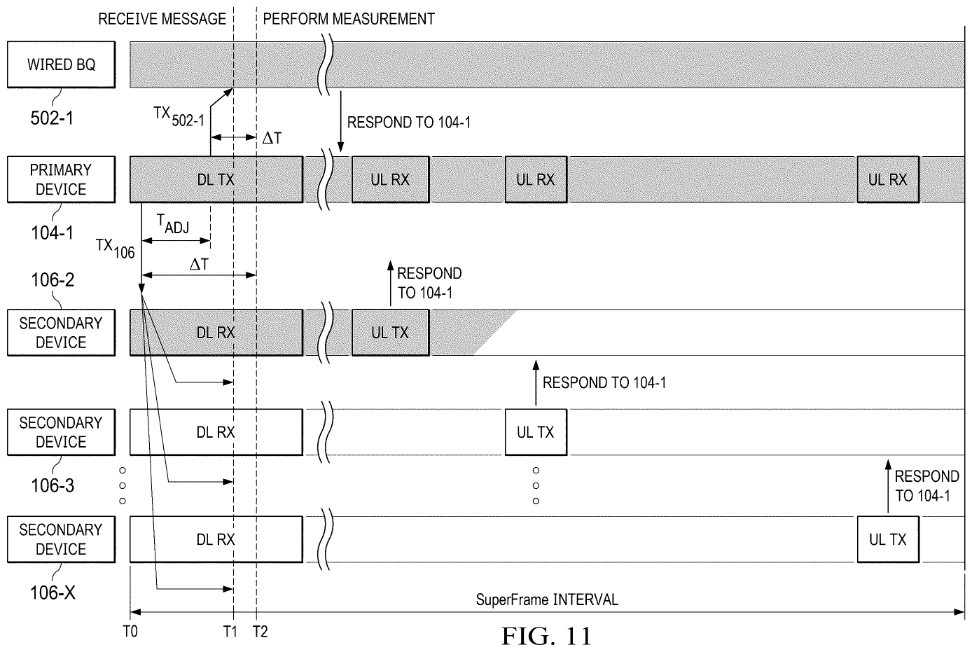

FIG. 12 is an illustrative example of Bluetooth Low Energy (BLE) Frequency channels utilized by the primary devices within the WMBS of FIG. 6. FIG. 12 includes thirty-seven data channels in the industrial, scientific, and medical (ISM) band. These channels are used by both the primary devices 104-1 and 104-2 to wirelessly exchange data (including but not limited to battery measurement data) with the secondary devices 106. In some examples, adjacent channels may be separated by a sufficiently large frequency gap (e.g., 5 MHz or 10 MHz as described above in connection with FIGS. 7A and 7B) that the risk of two devices interfering with one another by wirelessly communicating over adjacent channels is negligible. However, in other examples such as FIG. 12, adjacent channels are separated by a smaller frequency gap (e.g., 2 MHz). Thus, in examples such as FIG. 12, two devices wirelessly communicating over adjacent channels presents a comparatively large risk of interference. This comparatively large risk can decrease the performance of the WBMS 100 if unaddressed.

FIG. 12 also shows three advertising channels are utilized by the primary devices 104-1 and 104-2 to carry configuration data (including but not limited to commands such as the instructions that prompt the BQ circuits 502 to perform voltage measurements, commands for device joining, pairing, and negotiating, etc.). The advertising channels have adjacent indices but do not have adjacent frequency bands. For example, FIG. 12 shows that channel 37 refers to 2402 MHz, channel 38 refers to 2426 MHz, and channel 39 refers to 2480 MHz. Accordingly, the primary devices 104 can communicate on adjacent advertisement channels with negligible risk of interference. In some examples, the advertising channels are referred to as configuration channels.

FIG. 13 is an illustrative example of primary devices within the WMBS of FIG. 6 changing BLE frequency channels over time. FIG. 13 shows an example table 1300 that includes 37 rows and 12 columns. Column 1 describes the frequency channel utilized by a first primary device 104-1 (labeled P1 in the table 1300). Column 2 describes the frequency channel utilized by a second primary device that uses known techniques to determine its frequency (labeled P2_{KNOWN} in the table 1300). Column 3 describes the channel difference between columns 1 and 2 (labeled P1−P2_{KNOWN} in the table 1300). Column 4 describes the channel frequency channel utilized by a second primary device 104-2 that determines its frequency based on examples described herein (labeled P2_{EXAMPLE} in table 1300). Column 5 describes the channel difference between columns 1 and 4 (labeled P1−P2_{EXAMPLE} in table 1300). The rows describe how the frequency channels or channel differences of the foregoing channels change over time. All frequency channels in the example of FIG. 13 refer to the frequencies described above in connection with FIG. 12.

The first primary device 104-1 (P1) determines which frequencies to use for wireless communication based on a channel hopping scheme that is independent of any other primary devices 104 within the WBMS 100. Accordingly, in the example of FIG. 13, column 1 shows that P1 implements a channel hopping sequence by starting at channel 13, then transitioning to channel 31, then to channel 34, etc. P1 may utilize any suitable channel hopping sequence within the WBMS 100. In some examples, a frequency hopping sequence is referred to as a frequency hopping scheme. In general, primary devices 104 may change frequency channels at any frequency as determined by factors such as the superframe interval standard used, the number of devices communicating within a given superframe interval, instructions from the battery controller device 102-1, etc.

Column 2 shows that P2_{KNOWN} utilizes a time shifted version of the same frequency hopping scheme as P1. For example, the frequency channel of P2_{KNOWN} at row 1 is the same as the frequency channel of P1 at row 4 (24), the frequency channel of P2_{KNOWN} at row 2 is the same as the frequency channel of P1 at row 5 (4), etc. Thus, known systems attempt to avoid interference between multiple primary devices in a WBMS by having the primary devices temporally lag behind one another on the same frequency hopping sequence. Such a technique improves upon the naive approach of using independent frequency hopping sequences because it can guarantee that the primary devices do not share the exact same channel at the same time. However, a primary device that temporally lags behind another primary device on the same frequency scheme can still lead to interference. For example, column 3 shows that the difference between P1 and P2_{KNOWN} is only 3 channels in rows 13 and 30 and is only 2 channels in rows 17, 31, and 35. Channel differences of 3 and 2 corresponds to only 6 MHz and 4 MHz gaps, respectively, using the values of FIG. 12. Thus, in some situations, known techniques in which a primary device temporally lags behind another primary device on the same frequency scheme can fail to meet a minimum frequency separation (e.g., 10 MHz or 5 MHz) during wireless communications.

In contrast to the techniques utilized in known systems, P2_{EXAMPLE} utilizes the techniques described in examples herein by implementing equation (1):

$$Channel ( P {2}_{EXAMPLE} ) = ( Channel ( P 1 ) + offset ) \% {Num}_{Channels} \qquad ( 1 )$$

In equation (1), channel(x)′ refers to the frequency channel of a primary device x, ‘offset’ refers to a minimum channel value between the two primary devices, % refers to a modulo operation, and num_channels refers to the total number of data channels available within the WBMS 100. In some examples, the value of ‘offset’ is approximately equal to (num_channels/2). In the example of FIG. 13, P2_{EXAMPLE} implements equation (1) using an offset value of 10 and num_channels value of 37. Thus, the frequency channel at <row 1, column 4>=(13+10) % 37=23, the frequency channel at <row 2, column 4>=(31+10) % 37=4, the frequency channel at <row 3, column 4>=(34+10) % 37=7, etc. Column 5 indicates that by implementing equation (1), P2_{EXAMPLE} maintains a channel difference of at least the value of offset (e.g., 10) throughout the 37 frequency hops shown in table 1300. More generally, the examples described herein can ensure multiple primary devices 104 within a WBMS 100 maintain a minimum frequency distance while implementing any frequency hopping sequence, even if adjacent channels utilized by the frequency hopping sequence are less than the minimum frequency distance.

While the equation (1) and the examples described herein can ensure a minimum frequency distance at any given row, this benefit is lost if the primary devices 104-1 and 104-2 do not hop between frequencies at the same time. For example, if the primary device 104-1 inadvertently transitions from its channel listed in row 1 to its channels listed in row 2 before the primary device 104-2 does the same, then the channel distance between primary devices 104 is less than the expected ten channel minimum (as 31−23=8) for a period. More generally, primary devices 104 can fail to maintain a minimum frequency distance, and may therefore fail to meet safety and performance standards of the WBMS 100, by hopping between frequencies at different times. Accordingly, the frequency hopping sequences described herein may be referred to as time-divided frequency hopping sequences in some examples. Techniques to ensure the primary devices 104-1 and 104-2 are synchronized in time, and therefore hop between frequencies at the same time, are described further in connection with FIG. 18.

FIG. 14 is a flowchart representative of example machine-readable instructions or example operations 1400 that may be at least one of executed, instantiated, or performed by programmable circuitry to implement the just-in-time protocol described above. The example machine-readable instructions or operations 1400 of FIG. 14 begin when a controller device prepares messages that prompt two or more destination devices to perform an operation upon receipt. (Block 1402). In the example of FIG. 6, the controller device of FIG. 14 refers to the battery controller device 102-1. More generally, the controller device of FIG. 14 may refer to any number of battery controller devices 102, primary devices 104, or secondary devices 106. In the example of FIGS. 10 and 11, the destination devices of FIG. 14 refer to devices that are coupled to the battery controller device 102-1 using only wired mediums (e.g., the excitation source 602, the BQ pack-level device 604, and the BQ circuit 502-1). More generally, the destination devices that receive messages using the just-in-time protocol may generally refer to any of the BQ circuits 502, the excitation source 602, or the BQ pack-level device 604 of FIG. 6, regardless of whether the destination devices are coupled over wired or wireless mediums. The operations of FIG. 14 include but are not limited to: generating a stable AC signal, performing a pack-level current measurement of the battery cells 108, or performing a cell-level voltage measurement of the battery cells 108 as described above. In some examples, one or more of the messages of block 1402 are identical. In some examples, one or more of the messages of block 1402 are not identical but still cause the destination device to perform an operation upon receipt. In some examples, the messages of block 1402 prompt the destination devices to perform multiple operations at a set frequency.

The controller device determines the ΔT values between the controller device and the destination devices. (Block 1404). As described above in connection with FIGS. 10 and 11, a ΔT value refers to an amount of time between a) a transmission of a message from block 1402 to a destination device and b) the destination device starting the operation described in the message. A ΔT value is based in part on the communication latency between the controller device and destination device. Thus, ΔT values for destination devices that are coupled to the controller device over use a wireless medium are generally larger than the ΔT values for destination devices that are coupled to the controller device using only wired mediums. Communication latency also depends on the number of devices in a signal chain (e.g., the ΔT value between the battery controller device 102-1 and the BQ circuit 502-1 may be larger than the ΔT value between the battery controller device 102-1 and the BQ pack-level device 604 because the primary device 104-2 is an intermediate device in the signal chain between the battery controller device 102-1 and the BQ circuit 502-1). More generally, a given ΔT value may depend on any number of factors. Such factors include but are not limited to communication latency, processing operations (which may include demodulating, filtering, and interpreting data as described above), feedback operations (which may include allowing the excitation source physically provide a stable frequency and settle down after the initial impulse), etc. Thus, the ΔT values of one or more destination devices may be different from one another.

The controller device may determine the ΔT values through any suitable technique, including but not limited to empirical analysis as described above. In such examples, empirical analysis may be performed by test devices during a product design phase to determine ΔT values for a specific architecture of the WBMS 100. The ΔT values of such examples may then be preprogrammed into the controller device during a product manufacture phase and accessed during runtime at block 1404.

The controller device selects the destination device(s) with the longest remaining ΔT value of those that have not been sent a message. (Block 1406). For example, in FIG. 11, the controller device selects one of the BQ circuits 502-2 through 502-x before selecting the BQ circuit 502-1 because the BQ circuits 502-2 through 502-x communicate over a wireless medium (and therefore have larger communication latencies and larger ΔT values) than the BQ circuit 502-1. The controller device may select multiple destination devices at block 1406 if the ΔT values are approximately equal to one another. For example, in FIG. 11 the ΔT values of the BQ circuits 502-2 through 502-x are approximately equal because they all use secondary devices 106 to communicate wirelessly.

The controller device waits an amount of time based on the ΔT value of the selected destination device(s). (Block 1408). In general, the controller device waits until the difference between a desired operation time and the current time is ΔT. For example, suppose the BQ circuits 502-2 through 502-x of FIG. 11 are the selected destination devices of block 1408. In such an example, the desired operation for each selected device is the measurement at T2, so the controller device waits until T2−ΔT_{502-2 through 502-}x=T0 at block 1408.

The controller device transmits a message from block 1402 to the selected destination device(s). (Block 1410). The controller device then determines whether all destination devices from block 1402 have been sent a message. (Block 1412). If all of the destination devices have been sent a message (Block 1412: Yes), the machine-readable instructions or operations 1400 proceed to FIG. 16. If one or more destination devices from block 1402 have not yet received a message (Block 1412: No), control returns to block 1406 where the controller device selects the destination device(s) with the longest remaining ΔT value of those that have not been sent a message. Thus, by waiting an amount of time at block 1408 during each iteration, the just-in-time protocol ensures all destination devices that successfully receive the message synchronously perform operations at an expected time (e.g., T2 in FIG. 11) regardless of their varying ΔT values.

FIG. 15 is a flowchart representative of example machine-readable instructions or example operations that may be at least one of executed, instantiated, or performed using programmable circuitry to implement the schedule protocol as described above. The example machine-readable instructions or operations 1500 of FIG. 15 begin when one or more devices within the WBMS 100 synchronize their internal clocks to match a reference clock. (Block 1502). In general, the reference clock of block 15 is provided by one of the devices within a controller signal chain that implements the schedule protocol. Similarly, the devices that perform synchronization at block 1502 generally refer to the other controller devices within the signals chains that implement the schedule protocol. In the examples of FIGS. 8-9B, the primary device 104-1 provides the reference clock signal that the battery controller device 102-1 and the secondary devices 106-2 through 106-x synchronize to match. In other examples, different controller devices provide a reference clock or adjust to match a reference clock.

Adjusting an internal clock to adjust match a reference clock generally involves a comparison between two timestamps, where one timestamp refers to a time recorded with the internal clock and the other timestamp refers to the same time as recorded with the reference clock. The technique by which the timestamp corresponding to the reference clock is shared may depend on which device is generating the reference clock and which device is receiving the timestamp. For example, the timestamp generated with the reference clock may be located within a header of a superframe interval DL frame (as shown in FIG. 8), in the header of a response to a query time reference (as shown in FIG. 9A), in the header of a message that follows a GPIO interrupt (as shown in FIG. 9B), etc.

A controller device in the WBMS 100 prepares messages that prompt two or more destination devices to perform an operation upon receipt. (Block 1504). In the example of FIG. 6, the controller device of blocks 1504-1514 refers to the battery controller device 102-1. More generally, the controller device of blocks 1504-1514 may refer to any number of battery controller devices 102, primary devices 104, or secondary devices 106. In the example of FIG. 10A, the destination devices of FIG. 15 refer to devices that are coupled to the battery controller device 102-1 over a wireless mediums (e.g., the BQ circuits 502-(x+1) through 502-n). More generally, the destination devices that receive messages using the schedule protocol may generally refer to any of the BQ circuits 502, the excitation source 602, or the BQ pack-level device 604 of FIG. 6, regardless of whether the destination devices are coupled over wired or wireless mediums. The operations of FIG. 15 include but are not limited to: generating a stable AC signal, performing a pack-level current measurement of the battery cells 108, or performing a cell-level voltage measurement of the battery cells 108 as described above. In some examples, one or more of the messages of block 1504 are identical. In some examples, one or more of the messages of block 1504 are not identical but still cause the destination device to perform an operation at a scheduled time in the future. In some examples, the messages of block 1504 prompt the destination devices to perform multiple operations that start at the scheduled time and continue at a set frequency.

The controller device sends the messages to the destination devices. (Block 1506). In some examples, the controller device sends the messages of block 1506 at approximately the same time. For example, in FIG. 10A, the command issued at T1 is sent to all BQ circuits 502-(x+1) through 502-n during the DL frame of the subsequent superframe interval.

The controller device determines whether all destination devices that communicate over a wireless medium responded to the message. (Block 1508). In some examples, the destination devices respond to the message by sending an acknowledgement (ACK) message to the controller device that indicates the destination device has successfully received the message. The controller device implements block 1508 an amount of time after block 1506 to provide an opportunity for the destination devices to respond. In some examples, the controller device determines whether every destination device has responded to the message at block 1508, regardless of whether the destination devices are coupled over wireless or wired mediums.

If all controller devices that communicate over a wireless medium have responded to the message (Block 1508: Yes), the controller waits for the scheduled operations to occur. (Block 1514). The machine-readable instructions or operations 1500 proceed to FIG. 16 after block 1514.

Alternatively, if one or more controller devices that communicate over a wireless medium have not responded to the message (Block 1508: No), the controller device determines whether there is time for another transmission before the scheduled measurement of block 1504. (Block 1510). If the next transmission would occur after the scheduled measurement (Block 1510: No), the machine-readable instructions or operations 1500 proceed to block 1514. Alternatively, if there is time for another transmission before the scheduled measurement (Block 1510: Yes), the controller device retransmits the message to any wireless destination devices that have not provided a response. (Block 1512). The machine-readable instructions or operations 1500 then loop back to block 1508 where the controller device determines whether all wireless receiver devices have now responded to the message. By retransmitting the message one or more times at block 1512, the schedule protocol increases the probability that the receiver devices successfully receive the message and are ready to perform operations at the scheduled time.

In some examples, the machine-readable instructions or operations 1500 do not include block 1508. In those examples, the controller device continues to implement blocks 1510 and 1512 by retransmitting the command to all wireless destination devices in superframe intervals that occur before the scheduled time, regardless of which wireless destination devices have or have not acknowledged the command.

FIG. 16 is a flowchart representative of example machine-readable instructions or example operations that may be at least one of executed, instantiated, or performed using an example programmable circuitry implementation of the battery controller device of FIG. 6 to utilize measurement data and optionally implement one or more packet loss response techniques. The flowchart of FIG. 16 can be implemented by any controller device in the WBMS 100, regardless of whether the same or other controller devices in the WBMS 100 communicate with destination devices using a) only the just-in-time protocol, b) only the schedule protocol, or c) a combination of both protocols as described above. For example, the machine-readable instructions or operations 1400 (which include the just-in-time protocol at FIG. 14) continues to the flowchart of FIG. 16 if all destination devices have been sent a message (Block 1412: Yes). Similarly, the machine-readable instructions or operations 1400 (which include the schedule protocol at FIG. 15) continue to the flowchart of FIG. 16 after waiting for the scheduled operations to occur at block 1514.

Execution of the flowchart of FIG. 16 optionally begins a controller device determines whether the window of time for the destination devices to return measurement data has passed. (Block 1602). The window of block 1602 ends when the controller device expects to have received all measurement data from a given timestamp. For example, in FIG. 10A, the battery controller device 102-1 expects to receive all measurement data relating to the T2 measurement shortly after the end of superframe interval that follows T2. More generally, the window of block 1602 may refer to any length of time.

In some examples, conditions arise that cause a monitor circuit to transmit its measurement data later than originally expected by the controller device. For instance, suppose in FIG. 10A the BQ circuit 502-(x+2) successfully performs a measurement at T2. However, suppose further the UL frame that is normally assigned secondary device 106-(x+2) is temporarily reassigned during the subsequent superframe interval to a different BQ circuit 502-(x+3) (because, e.g., the BQ circuit 502-(x+3) has high priority information to report). Thus, the secondary device 106-(x+2) waits for one superframe interval to pass before reporting the T2 measurement data of the BQ circuit 502-(x+2). In such an example, the battery controller device 102-1 expects to receive the T2 measurement data of the BQ circuit 502-(x+2) shortly after the end of first superframe interval that follows T2 but actually receives said data after the end of the second superframe interval that follows T2. Therefore, in some examples, a controller device reevaluates block 1602 if it receives measurement data for a given timestamp after the window from the first iteration of block 1602 has passed.

If the window of block 1602 has not yet passed (Block 1602: No), the controller device waits an amount of time before reevaluating block 1602. Alternatively, if the window for the destination devices to return measurement data has passed (Block 1602: Yes), the controller device optionally determines whether a ratio of the actual number of measurements to the expected number of measurements satisfies a threshold. (Block 1604). A given monitor circuit may be unable to perform a measurement at an expected time for any reason. In some examples, the monitor circuit does not perform the measurement due to packet loss as described above. Also or alternatively, a monitor circuit may not perform the measurement because the monitor circuit triggered a higher priority fault indication that needs to be processed. Accordingly, the controller device may receive measurement data from only a subset of monitor circuits that were instructed to perform a measurement at a given timestamp. In this example, the ratio of block 1604 satisfies the threshold if the number of actual measurements divided by the number of expected measurements is greater or equal to a threshold number. If the ratio of the actual number of measurements to the expected number of measurements satisfies the threshold (Block 1604: Yes), the machine-readable instructions or operations 1400, 1500 proceed to block 1612.

If ratio of the actual number of measurements to the expected number of measurements does not satisfy the threshold (Block 1604: No), the controller device optionally performs oversampling. (Block 1606). As used above and herein, the term “sample” refers to one set of measurements that the monitor circuits perform synchronously at a given timestamp. Furthermore, “oversampling” may refer to sampling above a default rate of sampling, a normal rate of sampling, or a rate of sampling set by a safety standard/regulation (e.g., a standardized rate), etc. For example, over sampling occurs if a controller device scheduled measurements every 50 ms even if the default rate indicates measurements are only needed every 100 ms. Thus, a controller device may implement block 1606 may issuing instructions that, if successfully received by a given monitor circuit, increase the rate at which the monitor circuit perform battery measurements. A controller device may issue such instructions to increase the number of actual measurements that occur per unit of time. In some examples, a controller device that performs oversampling chooses whether to drop (e.g., disregard) the oversample data or use it when some portion of data is missed.

In the example of FIG. 16, the controller device reactively performs oversampling in response to a determination at block 1604 that a previous sampling rate was insufficient (e.g., in response to packet loss that occurred in the past). More generally, a controller device may decide to perform oversampling at any time. Thus, in some examples, a controller device proactively performs oversampling (by setting a high sampling rate before any of the messages of FIG. 14 or 15 are transmitted) to mitigate against potential packet loss that may occur in the future.

If the ratio of the actual number of measurements to the expected number of measurements does not satisfy the threshold (Block 1604: No), the controller device also has the option to disregard battery measurements for the current timestamp. (Block 1608). As used above and herein, disregarded measurement data refers to any measurement data that is collected by the monitor circuits but not used by a controller device to determine battery health status information at block 1612.

If the ratio of the actual number of measurements to the expected number of measurements does not satisfy the threshold (Block 1604: No), the controller device also has the option to adjust one or more battery health determination techniques to reflect the reduced number of measurements. (Block 1610). The adjustments of block 1612 may change a type, quality, or quantity of battery health monitoring operations based on a number of battery measurements that correspond to a timestamp.

The controller device determines battery information based on the measurements. (Block 1612). In some examples, the controller device performs EIS operations at block 1612 as described above. More generally, the controller device may perform any type of operations that determine the health, quality, or status of one or more of the battery cells 108. In some examples, the operations of block also or alternatively analyze, quantify, interpret, etc. the battery measurements based on their associated timestamps at block 1612. In some examples, the type, quality, or quantity of operations at block 1612 are different for certain portions of measurement data due to the adjustments of block 1610. In some examples, a controller device makes system level decisions (e.g., decisions that affect one or more components of the system 98) based on the determined battery information of block 1612.

The controller device determines whether to receive more measurements. (Block 1614). If the controller device does not receive additional measurements (Block 1614: No), the machine-readable instructions or operations 1400 and 1500 end. If the controller device does receive additional measurements (Block 1614: Yes), the example of FIG. 16 shows the machine-readable instructions 1400 return to block 1402 of FIG. 14 (where a controller device prepares additional messages based on the just-in-time protocol) and the machine-readable instructions or operations 1500 return to block 1502 of FIG. 15 where controller devices (where controller devices resynchronize their internal clocks in preparation to transmit additional messages based on the schedule protocol).

In other examples, one or more of the machine-readable instructions or operations 1400, 1500 return to block 1602 after the controller device determines to receive additional measurement data (Block 1614: Yes) because the messages of block 1402 or 1502 prompted the monitor circuits multiple measurements at different timestamps. More generally, the controller devices of the WBMS 100 may utilize measurement data and optionally implement one or more packet loss response techniques as described in FIG. 16 at any frequency. Furthermore, the frequency at which the operations of FIG. 16 are implemented may be independent of the frequency at which messages are transmitted under either the just-in-time protocol or the schedule protocol.

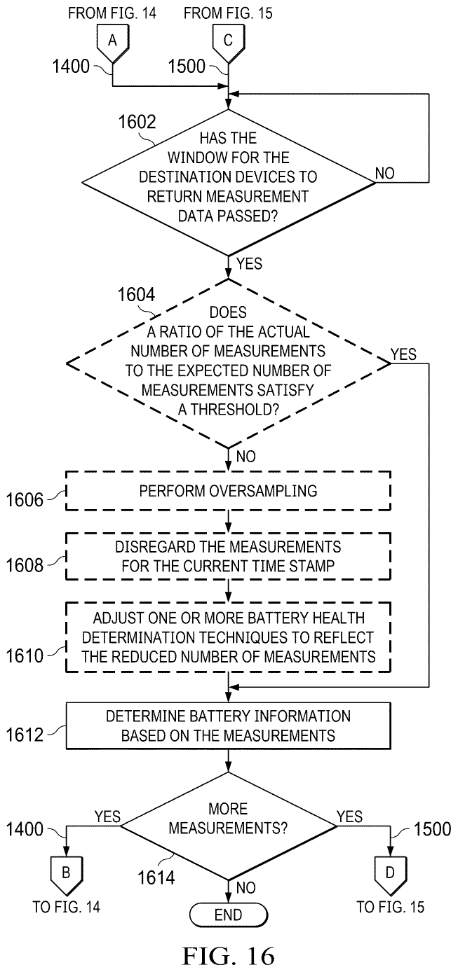

FIG. 17 is a flowchart representative of example machine-readable instructions or example operations 1700 that may be at least one of executed, instantiated, or performed using an example programmable circuitry implementation of the primary devices 104 in the WBMS 100 of FIG. 6. Accordingly, both primary devices 104-1 and 104-2 may implement the machine-readable instructions or operations 1700 independently of one another.

In examples where a given primary device 104-1 or 104-2 use the schedule protocol to provide instructions to one or more destination devices, execution of the flowchart of FIG. 17 begins when the given primary device synchronizes its internal clock with other controller devices in the WBMS 100. (Block 1702). Such synchronization operations may include but are not limited to: sending the internal clock signal to the secondary devices 106 and the battery controller 102-1, receiving a timestamp based on a reference clock signal that is generated by a different device, etc. as described above. In examples where a given primary device 104-1 or 104-2 only uses the just-in-time protocol the given primary device optionally implements block 1702.

The primary devices 104 both receive instructions from the battery controller device 102-1. (Block 1706). The instructions prompt one or more of the BQ circuits 502 to measure the voltages of their respective battery cells 108 at a certain time as described above.

The primary devices 104 both transmit messages to receiver devices based on the instructions. (Block 1708). The receiver devices of block 1708 refer to the next device in the signal chain between a given primary device and a given BQ circuit. Accordingly, the primary devices 104 may transmit the messages using either wired or wireless communications. The contents of the messages generated at block 1708 may prompt a given BQ circuit to perform a measurement upon receipt, or perform a measurement at a scheduled time, as described above. A given primary device may transmit one or more of the messages of block 1708 at different times, and may retransmit one or more of the messages, as described above. The receiver devices of the primary device 104-1 may overlap with, or be mutually exclusive from, the receiver device of the primary device 104-2 as described above.

In the example of FIG. 17, the primary devices 104 determine how to communicate with a given BQ circuit (e.g., whether to use the just-in-time protocol or the schedule protocol). The primary devices 104 then generate messages at block 1708 based on the foregoing determination and the instructions of block 1706. In other examples, the battery controller device 102-1 determines whether a given BQ circuit receives messages using the just-in-time protocol or the schedule protocol. In some of these other examples, the battery controller device 102-1 provides instructions that are already formatted in protocol-specific messages at block 1706. In turn, the primary devices forward the existing messages to the receiver devices at block 1708 of said examples instead of generating new messages.

The primary devices 104 both receive measurement data from one or more of the BQ circuits 502. (Block 1710). Some of the measurement data of block 1710 may arrive over a wireless medium and as part of a superframe interval format. Also or alternatively, some of the measurement data of block 1710 may arrive over a wired medium and not as part of a superframe interval.

The primary devices 104 both forward their received measurement data to the battery controller device 102-1. (Block 1712). In some examples, a given primary device combines (or formats, packages, etc.) data from multiple measurements into a single message that is transmitted at block 1712.

The primary devices 104 both determine whether to continue operations. (Block 1714). If a given primary device decides to stop operations (Block 1714: No), the machine-readable instructions or operations 1700 end for the given primary device.

Alternatively, if a given primary device decides to continue operations (Block 1714: Yes), the given primary device adjusts frequency channels for wireless communications. For example, the primary device 104-1 changes frequency channels using any suitable frequency hopping sequence and the primary device 104-2 changes frequency channels by implementing equation (1) as described above. The machine-readable instructions or operations 1700 return to block 1702 after block 1716.

In some examples, a given primary device implements the machine-readable instructions or operations 1700 by implementing one or more of blocks 1702-1716 in a different order than what is shown in FIG. 17. For example, the primary devices 104 may change frequency channels at any time (e.g., between some frames of some superframe intervals, between every frame of some superframe intervals, after some superframe intervals, after every superframe interval, etc.), so long as both primary devices 104 change frequency channels at the same time to maintain the minimum frequency separation enabled by equation (1). Thus, the primary devices 104 can change frequency channels at other times in addition to, or in replacement of, the time shown in FIG. 17 (after measurement data is forwarded but before more instructions are received). Furthermore, a given primary device may implement the machine-readable instructions or operations 1700 by implementing one or more of blocks 1702-1716 concurrently with one another.

FIG. 18 is a flowchart representative of example machine-readable instructions or example operations that may be at least one of executed, instantiated, or performed using an example programmable circuitry implementation of the primary device 104-2 in the WBMS of FIG. 6. In particular, the flowchart of FIG. 18 describes how the primary device 104-2 synchronizes its superframe interval in time with the superframe interval of the primary device 104-1 to ensure accurate frequency hopping as described above.

Execution of the flowchart of FIG. 18 begins when the primary device 104-2 starts a superframe interval at a predetermined time. (Block 1802). As used in FIG. 18, a start of a superframe interval starts refers to when the primary device 104 begins to transmit a DL frame to one or more corresponding secondary devices 106.

The primary device 104-2 determines whether a superframe interval from the primary device 104-1 started at the same time as the superframe interval of block 1802. (Block 1804). The primary device 104-2 can receive the superframe data of the primary device 104-1 because the two devices are coupled to one another over a wired medium. In this example, the primary device 104-1 shares timing data with the primary device 104-2 by transmitting a GPIO interrupt at the start of each superframe interval generated by the primary device 104-1. Accordingly, the primary device 104-2 evaluates block 1804 by comparing when the GPIO interrupt arrives to when the superframe interval of block 1802 began. In other examples, the primary device 104-1 shares timing data using a different communication protocol over the wired medium. In the example of FIG. 18, the primary device 104-1 does not exchange timing data with the primary device 104-2 over a wireless medium because the primary devices 104 intentionally use different frequency channels when communicating wirelessly to avoid interference. In other examples, the primary devices 104 share the same frequency at the beginning of a superframe interval to communicate with one another and then change to different frequencies for the rest of the superframe.

In this example, the primary device 104-1 sends a GPIO interrupt once per superframe interval as described above. The primary device 104-1 also sends GPIO interrupts during both active and keep-alive modes to prevent the primary device 104-2 from falling out of synchronization due to clock drift. In other examples, the primary device 104-1 sends multiple GPIO interrupts per superframe interval (e.g., at the start of both the DL frame and one or more of the UL frames) to provide additional opportunities for the primary device 104-2 to resynchronize. A designer or manufacturer of primary devices may choose a frequency to generate GPIO interrupts by balancing the computational resource strain of transmitting, interpreting, and analyzing a GPIO interrupt against an estimated rate of clock drift of the primary device 104-2.

The superframe intervals of block 1804 preferably start at the same time because the primary devices 104 are already synchronized with one another. Accordingly, the primary device 104-2 checks for the presence of a GPIO interrupt at least once at the start of its own superframe interval (e.g., at the predetermined time of block 1802). However, the primary device 104-2 is also ready to receive the GPIO interrupt before the superframe interval begins (e.g., during the DL guard) in case the primary device 104-1 starts its superframe interval before the primary device 104-2 does the same.

If the two superframe intervals do start at the same time (Block 1804: Yes), the machine-readable instructions or operations 1800 proceed to block 1812. Alternatively, if the superframe intervals do not start at the same time (Block 1804: No), the primary device 104-2 measures the difference between the start of the two DL frames. (Block 1806). The primary device 104-2 implements block 1806 by comparing the predetermined time of block 1802 to the time when the GPIO interrupt is received from the primary device 104-1. Accordingly, the primary device 104-2 may continually or repeatedly check for the presence of a GPIO interrupt multiple times throughout the superframe interval (e.g., during the DL frame, during one or more of the UL frames if necessary, etc.) until the GPIO interrupt is received.

The primary device 104-2 adjusts the DL frame of its next superframe interval based on the measured difference. (Block 1808). For example, if the measured difference of block 1806 indicated the GPIO interrupt arrived 500 microseconds (μs) before the DL frame of block 1802, the primary device 104-2 schedules the DL frame of the next iteration of block 1802 to occur 500 μs earlier than was originally planned. The primary device 104-2 may also or alternatively adjust its internal Real Time Clock (RTC) timer based on the measured difference so that the next DL frame of the primary device 104-2 occurs at the same time as the next DL frame of the primary device 104-1.

The primary device 104-2 adjusts the UL frames of its next superframe interval based on the measured difference. (Block 1810). For example, if the measured difference of block 1810 indicated the GPIO interrupt arrived 500 μs after the DL frame of block 1802, the primary device 104-2 schedules the UL frames of the next iteration of block 1802 to occur 500 μs later than was originally planned. The primary device 104-2 may also or alternatively adjust its internal Real Time Clock (RTC) timer based on the measured difference so that the next UL frames of the primary device 104-2 occurs at the same time as the corresponding UL frames of the primary device 104-1.

The primary device 104-2 determines whether to continue. (Block 1812). In general, the primary device 104-2 continues implementing the flowchart of FIG. 18 so long as both primary devices 104 are still being instructed by the battery controller device 102-1 to issue superframe intervals. In doing so, the primary device 104-2 prevents internal clock drift from accumulating and supports the safety or performance requirements of the WBMS 100.

If the primary device 104-2 determines to continue (Block 1812: Yes), the primary device 104-2 waits until the predetermined start of the next DL frame (Block 1814) before starting the next superframe interval at block 1802. The predetermined start time of block 1814 reflects any adjustments the primary device 104-2 may have implemented at block 1808.

FIG. 19 is a flowchart representative of example machine-readable instructions or example operations that may be at least one of executed, instantiated, or performed using an example programmable circuitry implementation of a BQ circuit 502 in the WBMS of FIG. 6. The execution of FIG. 19 begins when a BQ circuit receives a first message from a primary device. (Block 1902). In some examples, the BQ circuit 502-1 receives the message of block 1902 directly from the primary device 104-1 over a wired medium. In other examples, the BQ circuit 502-2 receives the message of block 1902 from a secondary device 106-2 that communicates with the primary device 104-1 over a wireless medium.

The BQ circuit (e.g., 502-1) performs a voltage measurement of the associated battery cells (e.g., 108-1) based on the first message. (Block 1904). In some examples, the first message prompts the BQ circuit to perform one voltage measurement for all associated battery cells at block 1904. In other examples, the first message prompts the BQ circuit to perform one voltage measurement per associated battery cell at block 1904. In some examples, the BQ circuit performs the voltage measurement(s) upon receipt of the first message as described above. In other examples, the BQ circuit performs the voltage measurement(s) at a scheduled time indicated within the first message (as described above).

The BQ circuit prepares a second message that includes both the value of the measurement(s) and a timestamp of when the measurement(s) occurred. (Block 1906). The BQ circuit may format the second message using any suitable communication protocol. In some examples, the BQ circuit separates the measurement data from block 1904 into multiple messages that each contain or refer to a timestamp of when the measurements occurred. By including timestamps that describe when the respective monitor circuit performed the measurement, the BQ circuits 502 enable a controller device to reorganize measurement data that may be transmitted out of chronological order.

The BQ circuit transmits the second message to the primary device. (Block 1908). In some examples, the BQ circuit 502-1 implements block 1908 by providing the second message directly to the primary device 104-1 over a wired medium. In other examples, the BQ circuit 502-1 implements block 1908 by providing the second message to the secondary device 106-2, which in turn forwards the second message to the primary device 104-1 wirelessly and within a superframe interval. The machine-readable instructions or operations 1900 end after block 1908.

FIG. 20 is a flowchart representative of example machine-readable instructions or example operations that may be at least one of executed, instantiated, or performed using an example programmable circuitry implementation of the BQ pack-level device of FIG. 6. The machine-readable instructions or operations 2000 begin when the BQ pack-level device 604 receives a first message from the battery controller device 102-1. (Block 2002). In the example of FIG. 6, the BQ pack-level device 604 is directly coupled to the battery controller device 102-1 over a wired medium. In other examples, the BQ pack-level device 604 is configurable to receive communication from the battery controller device 102-1 over a wireless medium.

The BQ pack-level device 604 performs a current measurement of the pack of battery cells 108 based on the first message. (Block 2004). In the example of FIG. 10A, BQ pack-level device 604 performs the current measurement upon receipt of the first message. In other examples, the BQ pack-level device 604 performs the current measurement at a scheduled time indicated within the first message.

The BQ pack-level device 604 prepares a second message that includes both the value of the current measurement and a timestamp of when the current measurement occurred. (Block 2006). The BQ pack-level device 604 may format the second message using any suitable communication protocol. In some examples, the BQ pack-level device 604 separates the measurement data from block 2004 into multiple messages that each contain or refer to a timestamp of when the measurements occurred.

The BQ pack-level device 604 transmits the second message to the battery controller device 102-1. (Block 2008). In some examples, the BQ pack-level device 604 implements block 2008 by providing the second message directly to the battery controller device 102-1 over a wired medium. In other examples, the BQ pack-level device 604 implements block 1908 by providing the second message to the battery controller device 102-1 over a wireless medium. The machine-readable instructions or operations 2000 end after block 2008.

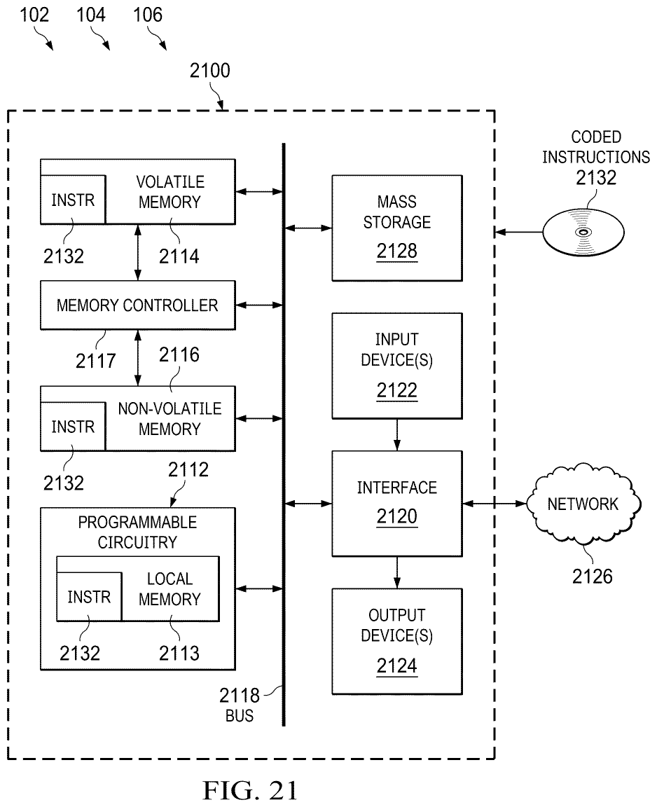

FIG. 21 is a block diagram of an example programmable circuitry platform 2100 structured to one or a combination of execute or instantiate one or more of the example machine-readable instructions or the example operations of FIGS. 14-20 to implement the WBMS 100 of FIG. 6. The programmable circuitry platform 2100 can be, for example, a server, a personal computer, a workstation, an Electronic Control Unit (ECU) or any other type of computing or electronic device. In this example, the programmable circuitry platform 2100 implements one or more of the battery controller devices 102, the primary devices 104, or the secondary devices 106.

The programmable circuitry platform 2100 of the illustrated example includes programmable circuitry 2112. The programmable circuitry 2112 of the illustrated example is hardware. For example, the programmable circuitry 2112 can be implemented by one or more integrated circuits, logic circuits, FPGAs, microprocessors, CPUs, GPUs, DSPs, or microcontrollers from any desired family or manufacturer. The programmable circuitry 2112 may be implemented by one or more semiconductor based (e.g., silicon based) devices.

The programmable circuitry 2112 of the illustrated example includes a local memory 2113 (e.g., a cache, registers, etc.). The programmable circuitry 2112 of the illustrated example is in communication with main memory 2114, 2116, which includes a volatile memory 2114 and a non-volatile memory 2116, by a bus 2118. The volatile memory 2114 may be implemented by one or more Synchronous Dynamic Random Access Memory (SDRAM), Dynamic Random Access Memory (DRAM), RAMBUS® Dynamic Random Access Memory (RDRAM®), or any other type of RAM device. The non-volatile memory 2116 may be implemented by one or a combination of flash memory or any other desired type of memory device. Access to the main memory 2114, 2116 of the illustrated example is controlled by a memory controller 2117. In some examples, the memory controller 2117 may be implemented by one or more integrated circuits, logic circuits, microcontrollers from any desired family or manufacturer, or any other type of circuitry to manage the flow of data going to and from the main memory 2114, 2116.

The programmable circuitry platform 2100 of the illustrated example also includes interface circuitry 2120. The interface circuitry 2120 may be implemented by hardware in according to any type of interface standard, such as an Ethernet interface, a universal serial bus (USB) interface, a Bluetooth® interface, a near field communication (NFC) interface, a Peripheral Component Interconnect (PCI) interface, or a Peripheral Component Interconnect Express (PCIe) interface.

In the illustrated example, one or more input devices 2122 are connected to the interface circuitry 2120. The input device(s) 2122 permit(s) a user (e.g., a human user, a machine user, etc.) to enter one of or a combination of data or commands into the programmable circuitry 2112. The input device(s) 2122 can be implemented by, for example, one of or a combination of a battery cell, a monitor circuit, an excitation source, or another controller device.

One or more output devices 2124 are also connected to the interface circuitry 2120 of the illustrated example. The output device(s) 2124 can be implemented, for example, by one of or a combination of can be implemented by, for example, one of or a combination of a battery cell, a monitor circuit, an excitation source, or another controller device. In some examples, the output device(s) 2124 also or alternatively include display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, or speaker. The interface circuitry 2120 of the illustrated example, thus, includes one of or a combination of a graphics driver card, a graphics driver chip, or graphics processor circuitry such as a GPU.

The interface circuitry 2120 of the illustrated example also includes a communication device such as one of or a combination of a transmitter, a receiver, a transceiver, a modem, a residential gateway, a wireless access point, or a network interface to facilitate exchange of data with external machines (e.g., computing devices of any kind) by a network 2126. The communication can be by, for example, a Controller Area Network (CAN) connection, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 2100 of the illustrated example also includes one or more mass storage discs or devices 2128 to store one or more of firmware, software, or data. Examples of such mass storage discs or devices 2128 include one or more magnetic storage devices (e.g., floppy disk, drives, HDDs, etc.), optical storage devices (e.g., Blu-ray disks, CDs, DVDs, etc.), RAID systems, or solid-state storage discs or devices such as flash memory devices and SSDs.

The machine-readable instructions 2132, which may be implemented by the machine-readable instructions of FIGS. 14-20, may be stored in one of or a combination of the mass storage device 2128, in the volatile memory 2114, in the non-volatile memory 2116, or on at least one non-transitory computer readable storage medium such as a CD or DVD which may be removable.

While an example manner of implementing the WBMS 100 of FIG. 1 is illustrated in FIG. 6, one or more of the elements, processes, or devices illustrated in FIG. 6 may be combined, divided, re-arranged, omitted, eliminated, or implemented in any other way. Further, the battery controller device 102-1, the primary devices 104, the secondary devices 106, the BQ circuits 502, the excitation source 602, the BQ pack-level device 604, or, more generally, the example WBMS 100 of FIG. 6, may be implemented by hardware alone or by hardware in combination with software and firmware. Thus, for example, any of the battery controller device 102-1, the primary devices 104, the secondary devices 106, the BQ circuits 502, the excitation source 602, the BQ pack-level device 604, or, more generally, the example WBMS 100, could be implemented by programmable circuitry in combination with one or more machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), or field programmable logic device(s) (FPLD(s)) such as FPGAs. Further still, the example WBMS 100 of FIG. 6 may include one or more elements, processes, or devices in addition to, or instead of, those illustrated in FIG. 6, or may include more than one of any or all of the illustrated elements, processes and devices.

Flowchart(s) representative of example machine-readable instructions, which may be executed by programmable circuitry to at least one of implement or instantiate the WBMS 100 of FIG. 6 or representative of example operations which may be performed by programmable circuitry to at least one of implement or instantiate the WBMS 100 of FIG. 6, are shown in FIGS. 14-20. The machine-readable instructions may be one or more executable programs or portion(s) of one or more executable programs for execution by programmable circuitry such as the programmable circuitry 2112 shown in the example programmable circuitry platform 2100 described below in connection with FIG. 21 and may be one or more function(s) or portion(s) of functions to be performed by the example programmable circuitry (e.g., an FPGA). In some examples, the machine-readable instructions cause an operation, a task, etc., to be carried out or performed in an automated manner in the real-world. As used herein, “automated” means without human involvement.

The program may be embodied in instructions (e.g., software or firmware) stored on one or more non-transitory computer readable or machine-readable storage medium such as one of or a combination of cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), or any other storage device or storage disk. The instructions of the non-transitory computer readable or machine-readable medium may program or be executed by programmable circuitry located in one or more hardware devices, but the entire program or parts thereof could alternatively be executed or instantiated by one or more hardware devices other than the programmable circuitry or embodied in dedicated hardware. The machine-readable instructions may be distributed across multiple hardware devices or executed by two or more hardware devices (e.g., a server and a client hardware device). For example, the client hardware device may be implemented by an endpoint client hardware device (e.g., a hardware device associated with a human or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 14-20, many other methods of implementing the example WBMS 100 may alternatively be used. For example, the order of execution of the blocks of the flowchart(s) may be changed, or some of the blocks described may be changed, eliminated, or combined. Also or alternatively, any or all of the blocks of the flow chart may be implemented by one or more hardware circuits (e.g., processor circuitry, discrete, integrated analog or digital circuitry, an FPGA, an ASIC, a comparator, an operational-amplifier (op-amp), a logic circuit, etc.) structured to perform the corresponding operation without executing software or firmware. The programmable circuitry may be distributed in different network locations or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, one of or a combination of a CPU or an FPGA. The programmable circuitry may include one or more CPUs or one or more FPGAs located in the same package (e.g., the same integrated circuit (IC) package or in two or more separate housings), one or more CPUs or FPGAs in a single machine, one or multiple CPUs or FPGAs distributed across multiple servers of a server rack, multiple processors distributed across one or more server racks. Also or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., or any combination(s) thereof in any of the contexts described above.

The machine-readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, or produce machine executable instructions. For example, the machine-readable instructions may be fragmented and stored on one or more storage devices, disks or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., so they are directly readable, interpretable, or executable by a computing device or other machine. For example, the machine-readable instructions may be stored in multiple parts, which are individually compressed, encrypted, or stored on separate computing devices, so that the parts when decrypted, decompressed, or combined form a set of one or more computer-executable or machine executable instructions that implement one or more functions or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions or the corresponding program(s) can be executed in whole or in part. Thus, machine-readable, computer readable or machine-readable media, as used herein, may include one or a combination of instructions and program(s) regardless of the particular format or state of the machine-readable instructions or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 14-20 may be implemented using executable instructions (e.g., computer readable or machine-readable instructions) stored on one or more non-transitory computer readable or machine-readable media. As used herein, the terms non-transitory computer readable medium, non-transitory computer readable storage medium, non-transitory machine-readable medium, and non-transitory machine-readable storage medium are expressly defined to include any type of computer readable storage device or storage disk and to exclude propagating signals and to exclude transmission media. Examples of such non-transitory computer readable medium, non-transitory computer readable storage medium, non-transitory machine-readable medium, or non-transitory machine-readable storage medium include one or more optical storage devices, magnetic storage devices, an HDD, a flash memory, a read-only memory (ROM), a CD, a DVD, a cache, a RAM of any type, a register, or any other storage device or storage disk in which information is stored for any duration (e.g., for extended time periods, permanently, for brief instances, for temporarily buffering, for caching of the information). As used herein, the terms “non-transitory computer readable storage device” and “non-transitory machine-readable storage device” are defined to include any physical (mechanical, magnetic, electromechanical, or electrical) hardware to retain information for a time period, but to exclude propagating signals and to exclude transmission media. Examples of non-transitory computer readable storage devices or non-transitory machine-readable storage devices include one or a combination of random-access memory of any type, read only memory of any type, solid state memory, flash memory, optical discs, magnetic disks, disk drives, or redundant array of independent disks (RAID) systems. As used herein, the term “device” refers to physical structure such as one of or a combination of mechanical, electromechanical, or electrical equipment, hardware, or circuitry that may or may not be configured by computer readable instructions, machine-readable instructions, etc., or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “or” when used, for example, in a form such as A, B, or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and things, the phrase “at least one of A and B” refers to implementations including any of (1) at least one A, (2) at least one B, or (3) at least one A and at least one B. Similarly, as used herein in the context of describing structures, components, items, objects and things, the phrase “at least one of A or B” refers to implementations including any of (1) at least one A, (2) at least one B, or (3) at least one A and at least one B. As used herein in the context of describing the performance or execution of processes, instructions, actions, activities, etc., the phrase “at least one of A and B” refers to implementations including any of (1) at least one A, (2) at least one B, or (3) at least one A and at least one B. Similarly, as used herein in the context of describing the performance or execution of processes, instructions, actions, activities, etc., the phrase “at least one of A or B” refers to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Also, although individual features may be included in different examples or claims, these may possibly be combined, and the inclusion in different examples or claims does not imply that a combination of features is at least one of not feasible or advantageous.

As used herein, connection references (e.g., attached, coupled, connected, and joined) may include intermediate members between the elements referenced by at least one of the connection reference or relative movement between those elements unless otherwise indicated. As such, connection references do not necessarily infer that two elements are directly connected or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, or ordering in any way, but are merely used as at least one of labels or arbitrary names to distinguish elements for ease of understanding the described examples. In some examples, the descriptor “first” may be used to refer to an element in the detailed description, while the same element may be referred to in a claim with a different descriptor such as “second” or “third.” In such instances, such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to at least one of manufacturing tolerances or other real-world imperfections. For example, “approximately” and “about” may indicate such dimensions may be within a tolerance range of +/−10% unless otherwise specified herein.

As used herein, the phrase “in communication,” including variations thereof, encompasses one of or a combination of direct communication or indirect communication through one or more intermediary components, and does not require direct physical (e.g., wired) communication or constant communication, but rather also includes selective communication at least one of periodic intervals, scheduled intervals, aperiodic intervals, or one-time events.

As used herein, “programmable circuitry” is defined to include at least one of (i) one or more special purpose electrical circuits (e.g., an application specific circuit (ASIC)) structured to perform specific operation(s) and including one or more semiconductor-based logic devices (e.g., electrical hardware implemented by one or more transistors), or (ii) one or more general purpose semiconductor-based electrical circuits programmable with instructions to perform one or more specific functions(s) or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations or functions, Field Programmable Gate Arrays (FPGAs) that may be programmed with second instructions to at least one of configure or structure the FPGAs to instantiate one or more operations or functions corresponding to the first instructions, Graphics Processor Units (GPUs) that may execute first instructions to perform one or more operations or functions, Digital Signal Processors (DSPs) that may execute first instructions to perform one or more operations or functions, XPUs, Network Processing Units (NPUs) one or more microcontrollers that may execute first instructions to perform one or more operations or functions or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., at least one of programmed or hardwired) at a time of manufacturing by a manufacturer to at least one of perform the function or be configurable (or re-configurable) by a user after manufacturing to perform the function/or other additional or alternative functions. The configuring may be through at least one of firmware or software programming of the device, through at least one of a construction or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

In the description and claims, described “circuitry” may include one or more circuits. A circuit or device that is described herein as including certain components may instead be adapted to be coupled to those components to form the described circuitry or device. For example, a structure described as including one or more semiconductor elements (such as transistors), one or more passive elements (such as one of or a combination of resistors, capacitors, or inductors), or one or more sources (such as voltage or current sources) may instead include only the semiconductor elements within a single physical device (e.g., at least one of a semiconductor die or integrated circuit (IC) package) and may be adapted to be coupled to at least some of the passive elements or the sources to form the described structure either at a time of manufacture or after a time of manufacture, for example, by at least one of an end-user or a third-party.

Modifications are possible in the described embodiments, and other embodiments are possible, within the scope of the claims.

From the foregoing, it will be appreciated that example systems, apparatus, articles of manufacture, and methods have been described that enable next generation WBMSs to continue supporting the functionality and performance of prior WBMSs, regardless of whether the next generation WBMSs have more battery cells than the prior WBMSs or form a hybrid battery system with wired connections. Described systems, apparatus, articles of manufacture, and methods improve the efficiency of using a computing device by at least: generating messages that prompt a monitor circuit to perform an operation upon receipt of the message or at a scheduled time in the future, sending messages that prompt operations upon receipt at specific times based on differing communication latencies and processing latencies, using timestamps that refer to a known reference to synchronize internal clocks of one or more controller devices, scheduling measurements and interpreting data based on the likelihood of packet loss caused by wireless communications, using an example frequency hopping scheme that guarantees a minimum channel distance between primary devices, etc. Described systems, apparatus, articles of manufacture, and methods are also directed to one or more improvement(s) in the operation of a machine such as a computer or other electronic, electromechanical, or mechanical device.

What is claimed is:

1. A device comprising:
a transceiver; and
programmable circuitry coupled to the transceiver and configurable to cause the transceiver to:
wirelessly transmit a first message to a first monitor circuit, the first message to prompt the first monitor circuit to perform a first battery measurement upon receipt; and
transmit a second message to a second monitor circuit over a wired medium after transmitting the first message so that the first and second monitor circuits synchronously perform battery measurements.

2. The device of claim 1, wherein the programmable circuitry is configurable to delay the transmission of the second message relative to the transmission of the first message so that the first monitor circuit and the second monitor circuit receive the first and second messages synchronously with one another.

3. The device of claim 1, wherein the programmable circuitry is configurable to perform Electrochemical Impedance Spectroscopy (EIS) using the battery measurements.

4. The device of claim 1, wherein the transceiver is configurable to:
receive third messages asynchronously from both the first monitor circuit and the second monitor circuit, wherein each message of the third messages includes a battery measurement and a timestamp describing when the respective monitor circuit performed the battery measurement; and
analyze the battery measurements based on the timestamps in the third messages.

5. The device of claim 4, wherein each message of the third messages includes an indication of which monitor circuit performed the battery measurement.

6. The device of claim 4, wherein:
the first monitor circuit is one of a plurality of monitor circuits coupled over a wireless medium; and
the programmable circuitry is configurable to:
transmit the first message to the plurality of monitor circuits; and
receive a plurality of the third messages from the plurality of monitor circuits.

7. The device of claim 6, wherein the programmable circuitry is configurable to analyze the battery measurements by disregarding battery measurements that correspond to a timestamp if a number of measurements that correspond to the timestamp fails to satisfy a threshold number.

8. The device of claim 6, wherein the programmable circuitry is configurable to analyze the battery measurements by adjusting a type, quality, or quantity of battery health monitoring operations based on a number of battery measurements that correspond to a timestamp, wherein a number of first monitor circuits that performed a battery measurement at the timestamp is fewer than all of the plurality of monitor circuits.

9. The device of claim 1, wherein:
the battery measurements are samples of battery cells; and
the programmable circuitry is configurable to oversample the battery cells by transmitting a message that prompts the first monitor circuit to perform battery measurements at a rate higher than a default rate.

10. A method comprising:
wirelessly transmitting a first message to a first monitor circuit, the first message to prompt the first monitor circuit to perform a first battery measurement upon receipt; and
transmitting a second message to a second monitor circuit over a wired medium after transmitting the first message so that the first and second monitor circuits synchronously perform battery measurements.

11. The method of claim 10, further comprising delaying the transmission of the second message relative to the transmission of the first message so that the first monitor circuit and the second monitor circuit receive the first and second messages synchronously with one another.

12. The method of claim 10, further comprising:
receiving third messages asynchronously from both the first monitor circuit and the second monitor circuit, wherein each message of the third messages includes a battery measurement and a timestamp describing when the respective monitor circuit performed the battery measurement; and
analyzing the battery measurements based on the timestamps in the third messages.

13. A system comprising:
a primary device;
a first monitor circuit coupled to a first battery cell; and
a second monitor circuit coupled to the primary device over a wired medium and coupled to a second battery cell,
wherein the primary device is configurable to:
wirelessly transmit a first message that prompts the first monitor circuit to perform a first battery measurement upon receipt; and
transmit a second message to a second monitor circuit over the wired medium after transmitting the first message so that the first and second monitor circuits synchronously perform battery measurements.

14. The system of claim 13, wherein the primary device is configurable to delay the transmission of the second message relative to the transmission of the first message so that:
the first monitor circuit and the second monitor circuit receive the first and second messages synchronously with one another.

15. The system of claim 13, wherein:
the primary device is configurable to receive third messages asynchronously from the first monitor circuit and the second monitor circuit, wherein each message of the third messages includes a battery measurement and a timestamp describing when the respective monitor circuit performed the battery measurement; and
the system further comprises a battery controller device coupled to the primary device and configurable to analyze the battery measurements based on their associated timestamps.

16. The system of claim 13, further comprising a battery controller device coupled to the primary device and configurable to perform Electrochemical Impedance Spectroscopy (EIS) using the battery measurements.

17. The system of claim 13, further comprising a battery controller device coupled to the primary device and configurable to disregard battery measurements that correspond to a timestamp if a number of measurements that correspond to the timestamp fails to satisfy a threshold number.

18. The system of claim 13, further comprising a battery controller device coupled to the primary device and configurable to, before the primary device transmits the first message, cause synchronization between a clock signal of the battery controller device and a clock signal of the primary device by exchanging a query time reference message with the primary device.

19. The system of claim 18, wherein the battery controller device is configurable to exchange the query time reference message using a Serial Peripheral Interface (SPI) protocol, a Universal Asynchronous Receiver Transmitter (UART) protocol, a General Purpose Input Output (GPIO) protocol, or a Controller Area Network (CAN) protocol.

20. The system of claim 13, wherein the primary device is configurable to prompt the first monitor circuit to perform a sequence of battery of measurements, the sequence including the first battery measurement.
